(19) United States
(12) Patent Application Publication
(10) Pub. No.: US 2026/0343490 A1
(43) Pub. Date: Oct. 29, 2026

(54) INFORMATION PROCESSING METHOD AND APPARATUS, DEVICE, CHIP, AND STORAGE MEDIUM

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 19/709,652

(22) Filed: Jun. 16, 2026

Related U.S. Application Data
(63) Continuation of application No. PCT/CN2023/139980, filed on Dec. 19, 2023.

(51) Int. Cl. H04W 68/00; H04W 52/02

(52) U.S. Cl. CPC H04W 68/005; H04W 52/0235

(57) ABSTRACT

Provided are information processing methods, apparatuses, devices, chips, and storage mediums. The method includes: receiving, by a terminal device, first configuration information transmitted by a core network device and/or second configuration information transmitted by a first base station; and determining, by the terminal device, enablement or disablement of a first low-power wake-up signal (LP-WUS) function and/or a second LP-WUS function based on the first configuration information and/or the second configuration information. The first LP-WUS function is used for monitoring paging initiated by the core network device (CN paging); and the second LP-WUS function is used for monitoring paging initiated by the first base station (RAN paging).

### CROSS-REFERENCE TO RELATED APPLICATION

This application is a continuation application of International Patent Application No. PCT/CN2023/139980 filed on Dec. 19, 2023, the entire content of which is incorporated herein by reference.

### TECHNICAL FIELD

Embodiments of the present disclosure relate to the technical field of mobile communication, and in particular, to information processing methods and apparatuses, devices, chips, and storage mediums.

### BACKGROUND

The 3rd Generation Partnership Project (3GPP) has introduced a Paging mechanism to the 5th-Generation (5G) New Radio (NR).

The main functions of the Paging mechanism include two aspects. On the one hand, it enables a network device to page a terminal device by using a Paging Message when the terminal device is in a Radio Resource Control (RRC) IDLE state or an RRC_INACTIVE state. On the other hand, it enables a network device to notify a terminal device of a system message change or public warning information such as an earthquake or a tsunami by using a Short Message, and in this case, the Paging mechanism is applicable to all RRC states of the terminal device, including the connected state.

However, for paging initiated by a core network device (CN paging), there still exists a large paging delay or paging failure.

### SUMMARY

Embodiments of the present disclosure provide information processing methods and apparatuses, devices, chips, and storage mediums.

According to a first aspect, an embodiment of the present disclosure provides an information processing method, the method including that: a terminal device receives first configuration information transmitted by a core network device and/or second configuration information transmitted by a first base station; and the terminal device determines enablement or disablement of a first ultra-Low Power Wakeup Signal (LP-WUS) function and/or a second LP-WUS function based on the first configuration information and/or the second configuration information, wherein the first LP-WUS function is used for monitoring of paging initiated by the core network device (CN paging), and the second LP-WUS function is used for monitoring of paging initiated by the first base station (RAN paging). In this way, a problem of increased CN paging delay or CN paging failure caused by inconsistent configurations provided by the first base station and the core network device for the LP-WUS function of the terminal device can be avoided, thereby helping to improve communication service quality.

According to a second aspect, an embodiment of the present disclosure provides an information processing method, the method including that: a core network device transmits first configuration information to a terminal device, wherein the first configuration information is used to configure enablement or disablement of a first LP-WUS function and/or a second LP-WUS function, the first LP-WUS function is used for monitoring of paging initiated by the core network device (CN paging), and the second LP-WUS function is used for monitoring of paging initiated by the first base station (RAN paging).

According to a third aspect, an embodiment of the present disclosure provides an information processing method, the method including that: a first base station transmits second configuration information to a terminal device, wherein the second configuration information is used to configure enablement or disablement of a first LP-WUS function and/or a second LP-WUS function, the first LP-WUS function is used for monitoring of paging initiated by the core network device (CN paging), and the second LP-WUS function is used for monitoring of paging initiated by the first base station (RAN paging).

According to a fourth aspect, an embodiment of the present disclosure provides an information processing method, the method including that: a first base station transmits third configuration information to a terminal device, and transmits the third configuration information to a core network device, wherein the third configuration information is used to configure enablement or disablement of a third LP-WUS function, and the third LP-WUS function is an LP-WUS-based function for monitoring of paging.

It may be understood that, in the embodiment of the present disclosure, the first base station notifies the core network device of the third configuration information configured for the terminal device. In this way, the terminal device, the first base station, and the core network device have a consistent understanding of an enablement or disablement state of the LP-WUS function of the terminal device, thereby overcoming a CN paging problem caused by an inconsistent understanding of the enablement or disablement state of the LP-WUS function of the terminal device. That is, it helps to reduce CN paging delay or decrease the number of CN paging failures, thereby further helping to improve communication service quality.

According to a fifth aspect, an embodiment of the present disclosure provides an information processing method, the method including that: a core network device receives third configuration information transmitted by a first base station, wherein the third configuration information is used to configure enablement or disablement of a third LP-WUS function of a corresponding terminal device, and the third LP-WUS function is an LP-WUS-based function for monitoring of paging.

According to a sixth aspect, an embodiment of the present disclosure provides an information processing method, the method including that: a terminal device receives third configuration information transmitted by a first base station, wherein the third configuration information is used to configure enablement or disablement of a third LP-WUS function, and the third LP-WUS function is an LP-WUS-based function for monitoring of paging.

According to a seventh aspect, an embodiment of the present disclosure provides an information processing apparatus implemented by a terminal device, the apparatus including: a receiving module, configured to receive first configuration information transmitted by a core network device and/or second configuration information transmitted by a first base station; and a determining module, configured to determine enablement or disablement of a first LP-WUS function and/or a second LP-WUS function based on the first configuration information and/or the second configuration information, wherein the first LP-WUS function is used for monitoring of paging initiated by the core network device (CN paging), and the second LP-WUS function is used for monitoring of paging initiated by the first base station (RAN paging).

According to an eighth aspect, an embodiment of the present disclosure provides an information processing apparatus implemented by a core network device, the apparatus including: a transmitting module, configured to transmit first configuration information to a terminal device, wherein the first configuration information is used to configure enablement or disablement of a first LP-WUS function and/or a second LP-WUS function, the first LP-WUS function is used for monitoring of paging initiated by the core network device (CN paging), and the second LP-WUS function is used for monitoring of paging initiated by the first base station (RAN paging).

According to a ninth aspect, an embodiment of the present disclosure provides an information processing apparatus implemented by a first base station, the apparatus including: a transmitting module, configured to transmit second configuration information to a terminal device, wherein the second configuration information is used to configure enablement or disablement of a first LP-WUS function and/or a second LP-WUS function, the first LP-WUS function is used for monitoring of paging initiated by the core network device (CN paging), and the second LP-WUS function is used for monitoring of paging initiated by the first base station (RAN paging).

According to a tenth aspect, an embodiment of the present disclosure provides an information processing apparatus implemented by a first base station, the apparatus including: a transmitting module, configured to transmit third configuration information to a terminal device and transmit the third configuration information to a core network device, wherein the third configuration information is used to configure enablement or disablement of a third LP-WUS function, and the third LP-WUS function is an LP-WUS-based function for monitoring of paging.

According to an eleventh aspect, an embodiment of the present disclosure provides an information processing apparatus implemented by a core network device, the apparatus including: a receiving module, configured to receive third configuration information transmitted by a first base station, wherein the third configuration information is used to configure enablement or disablement of a third LP-WUS function of a corresponding terminal device, and the third LP-WUS function is an LP-WUS-based function for monitoring of paging.

According to a twelfth aspect, an embodiment of the present disclosure provides an information processing apparatus implemented by a terminal device, the apparatus including: a receiving module, configured to receive third configuration information transmitted by a first base station, wherein the third configuration information is used to configure enablement or disablement of a third LP-WUS function, and the third LP-WUS function is an LP-WUS-based function for monitoring of paging.

According to a thirteenth aspect, an embodiment of the present disclosure provides a terminal device, including: a processor and a memory. The memory is configured to store a computer program; and the processor is configured to invoke and run the computer program stored in the memory, to perform the method according to the first aspect or perform the method according to the sixth aspect.

According to a fourteenth aspect, an embodiment of the present disclosure provides a first base station, including: a processor and a memory. The memory is configured to store a computer program; and the processor is configured to invoke and run the computer program stored in the memory, to perform the method according to the third aspect or perform the method according to the fourth aspect.

According to a fifteenth aspect, an embodiment of the present disclosure provides a core network device, including: a processor and a memory. The memory is configured to store a computer program; and the processor is configured to invoke and run the computer program stored in the memory, to perform the method according to the second aspect or perform the method according to the fifth aspect.

According to a sixteenth aspect, an embodiment of the present disclosure provides a chip, including a processor, the processor being configured to invoke and run a computer program from a memory, to cause a terminal device on which the chip is mounted to perform the method according to the first aspect or performs the method according to the sixth aspect.

According to a seventeenth aspect, an embodiment of the present disclosure provides a chip, including a processor, the processor being configured to invoke and run a computer program from a memory, to cause a first base station on which the chip is mounted to perform the method according to the third aspect or performs the method according to the fourth aspect.

According to an eighteenth aspect, an embodiment of the present disclosure provides a chip, including a processor, the processor being configured to invoke and run a computer program from a memory, to cause a core network device on which the chip is mounted to perform the method according to the second aspect or performs the method according to the fifth aspect.

According to a nineteenth aspect, an embodiment of the present disclosure provides a computer-readable storage medium for storing a computer program that causes a terminal device to perform the method according to the first aspect or perform the method according to the sixth aspect.

According to a twentieth aspect, an embodiment of the present disclosure provides a computer-readable storage medium for storing a computer program that causes a first base station to perform the method according to the third aspect or perform the method according to the fourth aspect.

According to a twenty-first aspect, an embodiment of the present disclosure provides a computer-readable storage medium for storing a computer program that causes a core network device to perform the method according to the second aspect or perform the method according to the fifth aspect.

According to a twenty-second aspect, an embodiment of the present disclosure provides a computer program product including computer program instructions that cause a terminal device to perform the method according to the first aspect or perform the method according to the sixth aspect.

According to a twenty-third aspect, an embodiment of the present disclosure provides a computer program product including computer program instructions that cause a first base station to perform the method according to the third aspect or perform the method according to the fourth aspect.

According to a twenty-fourth aspect, an embodiment of the present disclosure provides a computer program product including computer program instructions that cause a core network device to perform the method according to the second aspect or perform the method according to the fifth aspect.

According to a twenty-fifth aspect, an embodiment of the present disclosure provides a computer program that causes a terminal device to perform the method according to the first aspect or perform the method according to the sixth aspect.

According to a twenty-sixth aspect, an embodiment of the present disclosure provides a computer program that causes a first base station to perform the method according to the third aspect or perform the method according to the fourth aspect.

According to a twenty-seventh aspect, an embodiment of the present disclosure provides a computer-readable storage medium for storing a computer program that causes a core network device to perform the method according to the second aspect or perform the method according to the fifth aspect.

It should be understood that the above general description and the following detailed description are merely exemplary and explanatory and do not limit the present disclosure.

### BRIEF DESCRIPTION OF THE DRAWINGS

The accompanying drawings are described herein to provide a further understanding of the present disclosure, and constitute a part of the present disclosure. The exemplary embodiments of the present disclosure and the descriptions thereof are used to explain the present disclosure, and do not constitute an improper limitation to the present disclosure. In the accompanying drawings:

FIG. 1 is a schematic architectural diagram of a wireless communication system to which embodiments of the present disclosure may be applied;

FIG. 2 is a schematic diagram of a possible working principle of an LP-WUS provided by an embodiment of the present disclosure;

FIG. 3 is a first schematic flowchart of an implementation of an information processing method provided by an embodiment of the present disclosure;

FIG. 4 is a second schematic flowchart of an implementation of an information processing method provided by an embodiment of the present disclosure;

FIG. 5 is a third schematic flowchart of an implementation of an information processing method provided by an embodiment of the present disclosure;

FIG. 6 is a fourth schematic flowchart of an implementation of an information processing method provided by an embodiment of the present disclosure;

FIG. 7 is a fifth schematic flowchart of an implementation of an information processing method provided by an embodiment of the present disclosure;

FIG. 8 is a sixth schematic flowchart of an implementation of an information processing method provided by an embodiment of the present disclosure;

FIG. 9 is a first structural schematic diagram of an information processing apparatus provided by an embodiment of the present disclosure;

FIG. 10 is a second structural schematic diagram of an information processing apparatus provided by an embodiment of the present disclosure;

FIG. 11 is a third structural schematic diagram of an information processing apparatus provided by an embodiment of the present disclosure;

FIG. 12 is a fourth structural schematic diagram of an information processing apparatus provided by an embodiment of the present disclosure;

FIG. 13 is a fifth structural schematic diagram of an information processing apparatus provided by an embodiment of the present disclosure;

FIG. 14 is a sixth structural schematic diagram of an information processing apparatus provided by an embodiment of the present disclosure;

FIG. 15 is a structural schematic diagram of a communication device provided by an embodiment of the present disclosure;

FIG. 16 is a structural schematic diagram of a chip according to an embodiment of the present disclosure;

FIG. 17 is a schematic block diagram of a communication system provided by an embodiment of the present disclosure.

### DETAILED DESCRIPTION

The technical solutions in the embodiments of the present disclosure will be described below with reference to the accompanying drawings in the embodiments of the present disclosure. The described embodiments are some rather than all of the embodiments of the present disclosure. All other embodiments obtained by a person of ordinary skill in the art based on the embodiments of the present disclosure without creative efforts shall fall within the protection scope of the present disclosure.

Unless otherwise defined, all technical and scientific terms used herein have the same meaning as commonly understood by a person skilled in the technical field of the present disclosure. The terms used herein are merely for the purpose of describing the embodiments of the present disclosure and are not intended to limit the present disclosure.

The network architecture and service scenarios described in the embodiments of the present disclosure are intended to illustrate the technical solutions of the embodiments of the present disclosure more clearly, and do not constitute a limitation on the technical solutions provided in the embodiments of the present disclosure. A person of ordinary skill in the art may recognize that with the evolution of network architectures and the emergence of new service scenarios, the technical solutions provided in the embodiments of the present disclosure are also applicable to similar technical problems.

FIG. 1 is a schematic architectural diagram of a wireless communication system to which embodiments of the present disclosure may be applied. As shown in FIG. 1, the wireless communication system 10 may include a terminal device 101, an access network device 102, and a core network device 103. The access network device 102 may communicate with the terminal device 101 over an air interface. Multi-service transmission is supported between the terminal device 101 and the access network device 102.

It should be understood that the embodiments of the present disclosure are exemplarily described by taking the wireless communication system 10 as an example, but the embodiments of the present disclosure are not limited thereto. That is, the technical solutions of the embodiments of the present disclosure may be implemented by various wireless communication systems, such as a Long Term Evolution (LTE) system, an LTE Time Division Duplex (TDD) system, a Universal Mobile Telecommunication System (UMTS), an Internet of Things (IoT) system, a Narrow Band Internet of Things (NB-IoT) system, an enhanced Machine-Type Communications (eMTC) system, a 5G communication system (also referred to as an NR communication system), a future communication system, and the like.

The terminal device 101 may be any terminal device, including but not limited to a terminal device connected to the access network device 102 or another terminal device in a wired or wireless manner.

For example, the terminal device 101 may refer to an access terminal, User Equipment (UE), a subscriber unit, a subscriber station, a mobile station, a mobile platform, a remote station, a remote terminal, a mobile device, a user terminal, a terminal, a wireless communication device, a user agent, or a user apparatus. The access terminal may be a cellular phone, a cordless phone, a Session Initiation Protocol (SIP) phone, an IoT device, a satellite handheld terminal, a Wireless Local Loop (WLL) station, a Personal Digital Assistant (PDA), a handheld device with a wireless communication function, a computing device or another processing device connected to a wireless modem, an in-vehicle device, a wearable device, a terminal device in a 5G network or a terminal device in a future evolved network, and the like, which are not limited in the embodiments of the present disclosure. For ease of description, the above-mentioned devices are collectively referred to as a terminal device. There are generally a plurality of terminal devices 101, and one or more terminal devices 101 may be distributed in a cell managed by each access network device 102.

The access network device 102 is a device deployed in an access network to provide a wireless communication function for the terminal device 101. The access network device 102 may be of various types, such as macro base stations, micro base stations, relay stations, access points, and the like. In systems using different radio access technologies, a device having an access network device function may have different names. For example, in a 5G NR system, the device is referred to as a gNodeB or a gNB. With the evolution of communication technologies, the name “access network device” may change. Optionally, a communication relationship may be established between the terminal device 101 and the core network device 103 via the access network device 102. For example, in an LTE system, the access network device 102 may be an Evolved Universal Terrestrial Radio Access Network (EUTRAN) or one or more Evolutional NodeBs (eNBs or eNodeBs) in the EUTRAN; in a 5G NR system, the access network device 102 may be one or more gNBs in a Radio Access Network (RAN); the access network device 102 may also be a Next Generation Radio Access Network (NG RAN) device, or a radio controller in a Cloud Radio Access Network (CRAN), or the access network device 102 may be a relay station, an access point, an in-vehicle device, a wearable device, a hub, a switch, a bridge, a router, or a network device in a future evolved Public Land Mobile Network (PLMN), and the like.

The core network device 103 may be a 5G Core (5GC) device, for example, an Access and Mobility Management Function (AMF) device, an Authentication Server Function (AUSF) device, a User Plane Function (UPF) device, or a Session Management Function (SMF) device. Optionally, the core network device 103 may also be an Evolved Packet Core (EPC) device of an LTE network, for example, a Session Management Function+Core Packet Gateway (SMF+PGW-C) device. It should be understood that the SMF+PGW-C may implement functions that can be implemented by both the SMF and the PGW-C. During network evolution, the above core network device may also be called another name, or a new network entity may be formed by dividing functions of the core network, which is not limited in the embodiments of the present disclosure.

Communication may also be established between functional units in the wireless communication system 10 via next generation (NG) interfaces.

For example, the terminal device 101 may establish an air interface connection with the access network device 102 via an NR interface for transmitting user-plane data and control-plane signaling; the terminal device 101 may establish a control-plane signaling connection with the AMF via an NG interface 1 (N1 for short); the access network device 102, for example, a next generation radio access base station (gNB), may establish a user-plane data connection with the UPF via an NG interface 3 (N3 for short); the access network device 102 may establish a control-plane signaling connection with the AMF via an NG interface 2 (N2 for short); the UPF may establish a control-plane signaling connection with the SMF via an NG interface 4 (N4 for short); the UPF may exchange user-plane data with a data network via an NG interface 6 (N6 for short); the AMF may establish a control-plane signaling connection with the SMF via an NG interface 11 (N11 for short); and the SMF may establish a control-plane signaling connection with the PCF via an NG interface 7 (N7 for short). A communication connection may be established between the access network device 102 such as a gNB and another access network device 102 via an Xn interface.

FIG. 1 exemplarily shows the terminal device 101, the access network device 102, and the core network device 103. Optionally, the wireless communication system 10 may include more access network devices 102 and more core network devices 103, and other numbers of terminal devices may be included within a coverage range of the access network device 102, which is not limited in the embodiments of the present disclosure.

It should be noted that FIG. 1 only schematically shows a system to which the present disclosure may be applied by way of example. Certainly, the method shown in the embodiments of the present disclosure may also be applied to other systems. In addition, the terms “system” and “network” are often used interchangeably herein. The term “and/or” herein is merely an association relationship between associated objects, indicating that three relationships may exist, for example, A and/or B may indicate: A exists alone, A and B exist simultaneously, and B exists alone. In addition, the character “/” herein generally indicates that associated objects are in an “or” relationship. It should also be understood that the “indication” mentioned in the embodiments of the present disclosure may be a direct indication, an indirect indication, or an indication of an association relationship. For example, A indicates B may represent that A directly indicates B, for example, B may be obtained from A; or that A indirectly indicates B, for example, A indicates C, and B may be obtained from C; or that there is an association relationship between A and B. It should also be understood that the “correspond” mentioned in the embodiments of the present disclosure may indicate a direct correspondence or an indirect correspondence between two objects, an association relationship between two objects, or a relationship such as indicating and indicated, configurating and configured, and the like. It should also be understood that the “predefined” or “predefined rule” mentioned in the embodiments of the present disclosure may be implemented by pre-storing corresponding codes, tables, or by other manners for indicating relevant information in a device (for example, a terminal device, an access network device, or a core network device), and the specific implementation of the present disclosure is not limited thereto. For example, “predefined” may refer to defined in a protocol. It should also be understood that in the embodiments of the present disclosure, the “protocol” may refer to a standard protocol in the communication field, which for example, may include an LTE protocol, an NR protocol, and a related protocol applied to a future communication system, which is not limited in the present disclosure.

To facilitate understanding of the technical solutions of the embodiments of the present disclosure, related technologies of the embodiments of the present disclosure are described below. The following related technologies may be arbitrarily combined with the technical solutions of the embodiments of the present disclosure as optional solutions, which all fall within the protection scope of the embodiments of the present disclosure.

With the pursuit of rate, delay, high-speed mobility, and energy efficiency as well as the diversity and complexity of services in future life, the 3GPP international standards organization has started to develop 5G communication technologies. Main application scenarios of the 5G communication technology are: enhanced Mobile Broadband (eMBB), Ultra-Reliable Low-Latency Communication (URLLC), and massive Machine-Type Communications (mMTC).

A 5G NR system may also be deployed independently. In a 5G network environment, a new RRC state, namely an RRC_INACTIVE state, is defined for the purposes of reducing air interface signaling, quickly restoring a wireless connection, and quickly restoring a data service. This state is different from an RRC_IDLE state and an RRC_ACTIVE state.

RRC_IDLE state: mobility is UE-based cell selection and reselection, paging is initiated by a Core Network (CN), and a paging area is configured by the CN. No UE Access Stratum (AS) context exists on a base station side. No RRC connection exists.

RRC_CONNECTED state: an RRC connection exists, and a UE AS context exists on a base station and a UE. A network side knows that a location of the UE is at a specific cell level. Mobility is network-controlled mobility. Unicast data may be transmitted between the UE and the base station.

RRC_INACTIVE state: mobility is UE-based cell selection and reselection, a connection between CN and NR exists, a UE AS context exists on a certain base station, paging is triggered by a Radio Access Network (RAN), a RAN-based paging area is managed by the RAN, and a network side knows that a location of the UE is at a RAN-based paging area level.

In a 5G NR system, a main function of paging is to enable a network to page a UE by using a paging message when the UE is in an RRC_IDLE state or an RRC_INACTIVE state, or notify the UE of a system message change or earthquake/tsunami/public warning information by using a short message (applicable to all RRC states of the UE, including an RRC_CONNECTED state).

Paging includes a Physical Downlink Control Channel (PDCCH) scrambled by a Paging Radio Network Temporary Identifier (P-RNTI), and a Physical Downlink Shared Channel (PDSCH) scheduled by the PDCCH. A paging message may be transmitted in the PDSCH, and a short message is 8 bits in the PDCCH.

For a UE in an RRC_IDLE state or an RRC_INACTIVE state, since there is no other data communication between the UE and the network, to save power of the UE, the UE may discontinuously monitor a paging channel, namely adopting a paging Discontinuous Reception (DRX) mechanism. Under the paging DRX mechanism, the UE only needs to monitor paging during one Paging Occasion (PO) within each DRX cycle. A PO is composed of a plurality of PDCCH monitoring occasions in a paging search space. One PO includes X PDCCH monitoring occasions, where X is equal to the actual number of Synchronization Signal Blocks (SSBs) broadcast through a Master Information Block (MIB). In addition, there is a concept of Paging Frame (PF). A PF refers to one radio frame (for example, fixed at 10 ms), and the radio frame may include a plurality of POs or start positions of a plurality of POs.

A paging DRX cycle is jointly determined by a common cycle in system broadcast and a specific cycle configured in higher-layer signaling (for example, Non-access stratum (NAS) signaling). A UE uses a minimum one of the two cycles as a paging cycle. From a network perspective, one paging DRX cycle may include a plurality of POs. A position of a PO monitored by a UE is related to an ID of the UE. A specific manner of determining a PF and a PO of a UE in one paging DRX is as follows (TS 38.304):

A System Frame Number (SFN) of a PF may be determined by using the following formula:

(SFN+PF_offset)mod T=(T div N)*(UE_ID mod N)

An index i_s of a PO in a PF may be determined by using the following formula:

i_s=floor(UE_ID/N)mod Ns

Some parameters in the above formulas are explained as follows:

T: a DRX cycle for a UE to receive paging. A network broadcasts a default DRX cycle. If the RRC/higher layer configures a UE-specific DRX cycle for the UE, a minimum one of the network-broadcast DRX cycle and the UE-specific DRX cycle configured by the RRC/higher layer is used as the DRX cycle of the UE. If the RRC/higher layer does not configure a UE-specific DRX cycle for the UE, the network-broadcast DRX cycle is used as the DRX cycle of the UE.

N: the number of PFs included in one T.

Ns: the number of POs included in one PF.

PF_offset: a time-domain offset for determining a PF.

UE_ID: 5G-S-TMSI mod 1024.

After calculating the PF, the index of the PO, and the number of PDCCH monitoring occasions in the PO based on the above formulas, the UE only needs to know a start position of a first PDCCH monitoring occasion of the PO by using related configuration parameters. The start position is configured by higher-layer signaling. The UE blindly detects a paging message based on the determined PO.

Paging false alarm refers to a false alarm of paging. It can be seen from the above determination of a PO by a UE that the determination of the PO is related to the UE ID and the total number of PFs and POs. When there are many UEs in the system and the network cannot allocate a different PO for each UE, it may occur that a plurality of UEs correspond to one PO. If the network needs to page a certain UE on the PO, other UEs that originally have no paging message may be caused to perform additional blind detection, mainly including blind detection of a PDCCH and a corresponding PDSCH. For these UEs that originally have no paging message, such erroneous paging is a paging false alarm.

In the work items of R17, the 3GPP RAN plenary approved a further enhancement item for UE power saving (RP-193239). One objective of this item is to reduce unnecessary UE paging reception (that is, reducing paging false alarms) by designing an enhanced paging mechanism. Therefore, a Paging Early Indication (PEI) mechanism is introduced to the R17 UE power saving item. The basic working principle is as follows:

1. A PEI is designed based on a PDCCH. A network transmits a PEI before a PO. A UE decides according to a received PEI to normally monitor paging on a corresponding PO or skip paging monitoring.

2. A PEI may indicate wake-up based on UE grouping, that is, UEs allocated to a same PO are further divided into a plurality of UE groups, and a network may indicate which UE group or UE groups a paging message is for, so that UEs in other UE groups do not need to receive the paging message.

In project approval discussion of 3GPP Rel-18, it is desirable to consider a wake-up signal with lower power consumption, namely an ultra-Low Power Wakeup Signal (LP-WUS). Compared with the PEI mechanism of R17, the low power WUS saves more energy, and a separate receiver with lower power consumption (i.e., a Ultra-low Power receiver (LR)) is used for it, that is, a main receiver (Main Radio (MR)) is not used. After receiving a LP-WUS, the LR of a terminal starts a main receiver to monitor a paging message, so as to achieve the purpose of saving power. The LP-WUS may be applied to a UE in an RRC_IDLE/RRC_INACTIVE state, and may also be applied to a UE in an RRC_CONNECTED state.

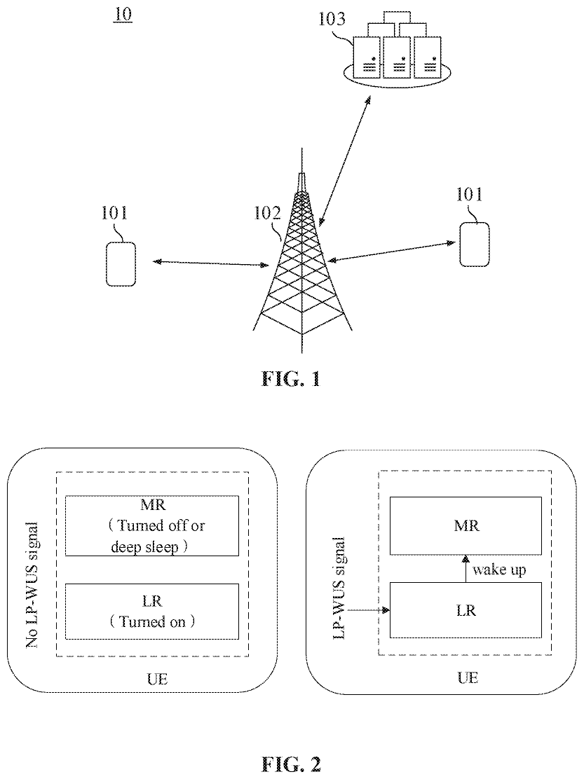

Optionally, FIG. 2 is a schematic diagram of a possible working principle of an LP-WUS provided by an embodiment of the present disclosure. As shown in FIG. 2, when an LP-WUS function is enabled, an LR monitors an LP-WUS, and an MR is in a deep sleep state; when the LR monitors the LP-WUS, a trigger signal is transmitted to the MR, where the trigger signal is used to wake up the MR to monitor a paging message.

Based on performance evaluation of an LP-WUS, although introduction of an LP-WUS receiver (namely, the LR) can reduce power consumption of a terminal, receiver sensitivity performance thereof is degraded compared with that of Rel-17 PEI, resulting in corresponding reduction of a coverage range that can be supported by the signal (as shown in Table 1 below). Therefore, a mechanism for switching a UE between an LP-WUS reception state and a normal MR reception state needs to be introduced.

TABLE 1
LP-WUS Performance Comparison

| solution | Range | Sensitivity | Power consumption | | signals |
|---|---|---|---|---|---|
| Rel-15 | >500 m | ~−100 dBm | 1X | | No WUS |
| IDLE | | | | | |
| R17 PEI | >500 m | ~−100 dBm | 30-50 mW | 0.8~0.9 X | R17 PEI- either |
| for IDLE | | | | | PDCCH based, or |
| | | | | | sequence (SSS/TRS |
| | | | | | like) based |
| AZP | 100 m~200 m | −70-−90 dBm | <100 uW | 0.001~0.01 X | New signal, based on |
| WUR | | | | | OOK waveform |

Optionally, when a UE is within the coverage of an LP-WUS, the UE may use an LR to monitor the LP-WUS; and when the UE is outside the coverage of the LP-WUS, the UE needs to use an MR to normally monitor paging. Therefore, for an entry condition and an exit condition for use of the LP-WUS, an intuitive definition manner is as follows:

1. Entry condition: including a measurement threshold of serving cell signal quality (such as an RSRP threshold). When the serving cell signal quality measured by the UE via the LR and/or the MR is greater than or equal to the threshold, the UE uses the LR to monitor the LP-WUS. The measurement threshold of serving cell signal quality may be configured by a network via a system message.

2. Exit condition: including a measurement threshold of serving cell signal quality (such as an RSRP threshold). When the serving cell signal quality measured by the UE via the LR and/or the MR is less than the threshold, the UE does not use the LR to monitor the LP-WUS, but uses the MR to monitor paging. The measurement threshold of serving cell signal quality may be configured by the network via a system message.

As described above, introduction of the LP-WUS can save power consumption of a UE on the one hand. On the other hand, for the UE in the RRC_IDLE state or the RRC_INACTIVE state, the MR of the UE is generally in an ultra-deep sleep state or a turned-off state during monitoring of the LP-WUS by the LR of the UE. Then, after the LR of the UE receives the LP-WUS and wakes up the MR, the MR needs to first perform processes such as downlink synchronization and measurement before receiving paging. Therefore, a relatively long wake-up time is required from reception of the LP-WUS by the UE to reception of paging. Based on related evaluation, the wake-up time may be up to 400 to 800 ms. It can be seen that use of the LP-WUS introduces additional paging delay.

Therefore, for a UE supporting an LP-WUS function, a network needs to determine whether to enable the LP-WUS function for the UE according to service characteristics of the UE, namely, introducing an enablement/disablement mechanism of the LP-WUS function. For example, if the UE has a power saving requirement and services of the UE are insensitive to delay, the network may configure a relatively large (e) DRX cycle for the UE, and configure the LP-WUS function to be enabled at the same time, namely, using an LP-WUS-based paging monitoring mechanism. For another example, if the UE has some delay-sensitive services, the network needs to configure a relatively small DRX cycle for the UE, and configure the LP-WUS function to be disabled at the same time, namely, not using the LP-WUS-based paging monitoring mechanism, but directly using the MR to monitor paging.

Sources of paging monitored by a UE in the RRC_IDLE state and the RRC_INACTIVE state may be different. For example, paging monitored by the UE in the RRC_IDLE state is all initiated by a core network (CN), therefore, paging monitoring parameters of the UE in the RRC_IDLE state are all configured by the core network. Paging monitored by the UE in the RRC_INACTIVE state may be initiated by an RAN or the CN. Therefore, when a base station releases the UE to the RRC_INACTIVE state, the base station usually configures another set of paging parameters for the UE with reference to configuration of the core network, for monitoring RAN paging. For the enablement/disablement configuration of the LP-WUS function, configuration by the core network and configuration by the base station may also exist. When the configuration parameter of the base station is inconsistent with the configuration parameter of the core network, a simple manner of solution is that the UE uses the configuration from the base station to monitor paging, but the following problems may exist:

1. If the core network configures to enable the LP-WUS function for the UE, and the base station configures to disable the LP-WUS function for the UE, the UE follows the configuration from the base station not to monitor an LP-WUS, but uses the MR to normally monitor paging. However, when the core network initiates CN paging for the UE in the RRC_INACTIVE state, the core network notifies base stations paging the UE that the LP-WUS function is enabled for the UE, so that the base stations first transmit LP-WUSs to the UE and then transmit paging. In this way, unnecessary LP-WUS transmission is caused on the one hand, which wastes system resources, and unnecessary paging delay is caused on the other hand.

2. If the core network configures to disable the LP-WUS function for the UE, and the base station configures to enable the LP-WUS function for the UE, the UE follows the configuration from the base station to monitor an LP-WUS, and determines whether to wake up the MR to normally monitor paging according to reception of the LP-WUS. However, when the core network initiates CN paging for the UE in the RRC_INACTIVE state, the core network notifies base stations paging the UE that the LP-WUS function is disabled for the UE, so that the base stations directly transmit paging to the UE. Since the UE does not receive the LP-WUS, the UE does not turn on the MR to monitor paging, so that the network cannot page the UE.

Therefore, when both the core network and the base station configure indication information for enabling/disabling the LP-WUS function for the UE, it needs to define a behavior of a UE about how the UE monitors paging from a standard perspective.

To facilitate understanding of the technical solutions of the embodiments of the present disclosure, the technical solutions of the present disclosure are described in detail below by means of specific embodiments. The above related technologies may be arbitrarily combined with the technical solutions of the embodiments of the present disclosure as optional solutions, which all fall within the protection scope of the embodiments of the present disclosure. The embodiments of the present disclosure include at least part of the following content.

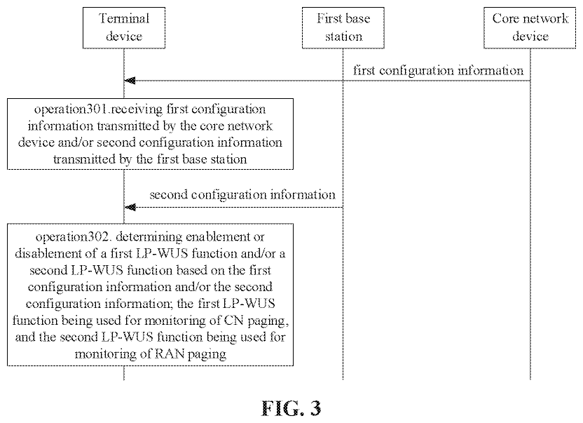

An embodiment of the present disclosure provides an information processing method. FIG. 3 is a first schematic flowchart of an implementation of the information processing method provided by the embodiment of the present disclosure. As shown in FIG. 3, the method includes the following operations 301 and 302:

Operation 301: A terminal device receives first configuration information transmitted by a core network device and/or second configuration information transmitted by a first base station.

Operation 302: The terminal device determines (i.e., configures) enablement or disablement of a first LP-WUS function and/or a second LP-WUS function based on the first configuration information and/or the second configuration information.

The first configuration information is used to configure enablement or disablement of the first LP-WUS function and/or the second LP-WUS function. The second configuration information is used to configure enablement or disablement of the first LP-WUS function and/or the second LP-WUS function. The first LP-WUS function is used for monitoring of paging initiated by the core network device (CN paging), i.e., monitoring of CN paging by the first LP-WUS function is LP-WUS-based. The second LP-WUS function is used for monitoring of paging initiated by the first base station (RAN paging), i.e., monitoring of RAN paging through the second LP-WUS function is LP-WUS-based monitoring.

It may be understood that the information processing method shown in FIG. 3 may include, but is not limited to, the following 10 listed combined solutions.

### Combined Solution 1:

When the terminal device is in an RRC_INACTIVE state, the terminal device receives the first configuration information transmitted by the core network device and the second configuration information transmitted by the first base station; the terminal device determines enablement or disablement of the first LP-WUS function based on the first configuration information; the terminal device determines enablement or disablement of the second LP-WUS function based on the second configuration information.

It may be understood that in Combined Solution 1, the terminal device configures enablement or disablement of the first LP-WUS function based on the received first configuration information transmitted by the core network device, and the terminal device configures enablement or disablement of the second LP-WUS function based on the received second configuration information transmitted by the first base station. Paging monitored by the first LP-WUS function and the second LP-WUS function is associated with a device that configures enablement or disablement of the LP-WUS function. That is, the device that configures the first LP-WUS function is the core network device, so paging monitored by the first LP-WUS function is CN paging. The device that configures the second LP-WUS function is the first base station, so paging monitored by the second LP-WUS function is RAN paging. In this way, when configuration of the LP-WUS function of the terminal device by the first base station is inconsistent with configuration of the LP-WUS function of the terminal device by the core network device, since monitoring of CN paging follows the configuration of the LP-WUS function by the core network device, a CN paging problem (such as increased paging delay or paging failure) caused by inconsistent configurations of the LP-WUS function provided by the first base station and the core network device for the terminal device is overcome, thereby helping to improve communication service quality.

### Combined Solution 2:

When the terminal device is in the RRC_INACTIVE state, the terminal device receives the first configuration information, and the terminal device determines enablement or disablement of the first LP-WUS function and the second LP-WUS function based on the first configuration information.

It may be understood that in Combined Solution 2, when the terminal device in the RRC_INACTIVE state receives the first configuration information transmitted by the core network device but does not receive the second configuration information transmitted by the first base station, i.e., only the core network device configures the first configuration information for the terminal device, the terminal device adopts a same monitoring policy for CN paging and RAN paging, i.e., the terminal device monitors CN paging and RAN paging based on the first configuration information.

In this way, for configuration of a monitoring policy of RAN paging, the first base station does not need to transmit the second configuration information, thereby helping to save transmission resources. On the other hand, when the first base station does not transmit the second configuration information, the terminal device determines enablement or disablement of the second LP-WUS function by default based on the first configuration information transmitted by the core network device, thereby overcoming a CN paging problem caused by inconsistent configurations of the LP-WUS function provided by the first base station and the core network device for the terminal device.

### Combined Solution 3:

When the terminal device is in the RRC_INACTIVE state, the terminal device receives the first configuration information, and the terminal device determines enablement or disablement of the first LP-WUS function based on the first configuration information.

It may be understood that in Combined Solution 3, when the terminal device in the RRC_INACTIVE state receives the first configuration information transmitted by the core network device but does not receive the second configuration information transmitted by the first base station, the terminal device monitors CN paging based on the first configuration information.

For monitoring of RAN paging, optionally, in some embodiments, the method may further include:
when the terminal device is in the RRC_INACTIVE state, the terminal device determines enablement or disablement of the second LP-WUS function based on first indication information.

The first indication information is predefined (e.g., to enable or disable the second LP-WUS function), or the first indication information is from a broadcast message transmitted by a base station, or the first indication information is from first signaling transmitted by a base station, where the first signaling is specific signaling for the terminal device.

In this way, when the core network device transmits the first configuration information to the terminal device but the first base station does not transmit the second configuration information to the terminal device, the terminal device determines enablement or disablement of the first LP-WUS function based on the first configuration information, and the terminal device determines enablement or disablement of the second LP-WUS function based on the first indication information, thereby overcoming a CN paging problem caused by inconsistent configurations of the LP-WUS function provided by the first base station and the core network device for the terminal device.

In a possible implementation, the base station that broadcasts the first indication information via a broadcast message or transmits the first indication information via first signaling may be a serving base station of the terminal device, and the base station may also be the first base station or another base station different from the first base station.

In this embodiment of the present disclosure, the first signaling may be various types of specific signaling for the terminal device, and is not limited to an RRC connection release message.

### Combined Solution 4:

When the terminal device is in the RRC_INACTIVE state, the terminal device receives the first configuration information, and the terminal device determines enablement or disablement of the first LP-WUS function based on the first configuration information.

It may be understood that in Combined Solution 4, the first base station does not transmit the second configuration information to the terminal device, and the terminal device only receives the first configuration information transmitted by the core network device. In this way, for monitoring of RAN paging, optionally, in some embodiments, the first base station may indicate the terminal device through implicit configuration to disable the second LP-WUS function. For example, the first base station does not transmit the second configuration information to the terminal device, thereby helping to save transmission resources. Correspondingly, for the terminal device, the method may further include: when the terminal device is in the RRC_INACTIVE state, the terminal device disables the second LP-WUS function.

In this way, when the terminal device in the RRC_INACTIVE state receives the first configuration information but does not receive the second configuration information, the terminal device may determine enablement or disablement of the first LP-WUS function based on the first configuration information and disable the second LP-WUS function, thereby overcoming a CN paging problem caused by inconsistent configurations of the LP-WUS function provided by the first base station and the core network device for the terminal device.

### Combined Solution 5:

When the terminal device is in the RRC_INACTIVE state, the terminal device receives the second configuration information, and the terminal device determines enablement or disablement of the second LP-WUS function based on the second configuration information.

It may be understood that in Combined Solution 5, the core network device does not transmit the first configuration information to the terminal device, and the terminal device only receives the second configuration information transmitted by the first base station. In this way, for monitoring of CN paging, optionally, in some embodiments, the core network device may indicate the terminal device through implicit configuration to disable the first LP-WUS function. For example, the core network device does not transmit the first configuration information to the terminal device, thereby helping to save transmission resources. Correspondingly, for the terminal device, the method may further include: when the terminal device is in the RRC_INACTIVE state, the terminal device disables the first LP-WUS function.

In this way, when the terminal device in the RRC_INACTIVE state does not receive the first configuration information but receives the second configuration information, the terminal device may disable the first LP-WUS function and determine enablement or disablement of the second LP-WUS function based on the second configuration information, thereby overcoming a CN paging problem caused by inconsistent configurations of the LP-WUS function provided by the first base station and the core network device for the terminal device.

### Combined Solution 6:

When the terminal device is in the RRC_IDLE state, the terminal device receives the first configuration information and the second configuration information. The terminal device in the RRC_IDLE state determines enablement or disablement of the first LP-WUS function based on the first configuration information. When the terminal device switches from the RRC_IDLE state to the RRC_INACTIVE state, the terminal device in the RRC_INACTIVE state determines enablement or disablement of the first LP-WUS function based on the first configuration information, and the terminal device in the RRC_INACTIVE state determines enablement or disablement of the second LP-WUS function based on the second configuration information.

In this way, a CN paging problem caused by inconsistent configurations of the LP-WUS function provided by the first base station and the core network device for the terminal device is overcome.

### Combined Solution 7:

When the terminal device is in the RRC_IDLE state, the terminal device receives the first configuration information, and the terminal device determines enablement or disablement of the first LP-WUS function based on the first configuration information.

In a possible implementation, paging monitored by the terminal device in the RRC_IDLE state is all initiated by the core network device. Only the core network device transmits the first configuration information to the terminal device, and the terminal device determines enablement or disablement of the first LP-WUS function based on the first configuration information, and monitors CN paging based on this.

### Combined Solution 8:

When the terminal device is in the RRC_INACTIVE state, the terminal device receives the second configuration information but does not receive the first configuration information, and the terminal device determines enablement or disablement of the first LP-WUS function and the second LP-WUS function based on the second configuration information. In this way, a CN paging problem caused by inconsistent configurations of the LP-WUS function provided by the first base station and the core network device for the terminal device is overcome.

### Combined Solution 9:

When the terminal device is in the RRC_INACTIVE state, the terminal device receives the first configuration information and the second configuration information, and the terminal device determines enablement or disablement of the first LP-WUS function based on the first configuration information and the second configuration information. Further, in some embodiments, the operation that the terminal device determines enablement or disablement of the first LP-WUS function based on the first configuration information and the second configuration information may include: when both the first configuration information and the second configuration information indicate enablement of the LP-WUS function, the terminal device enables the first LP-WUS function; and/or when both the first configuration information and the second configuration information indicate disablement of the LP-WUS function, the terminal device disables the first LP-WUS function. In this way, a CN paging problem caused by inconsistent configurations of the LP-WUS function provided by the first base station and the core network device for the terminal device is overcome.

### Combined Solution 10:

When the terminal device is in the RRC_INACTIVE state, the terminal device receives the first configuration information and the second configuration information, and the terminal device determines enablement or disablement of the second LP-WUS function based on the first configuration information and the second configuration information. Further, in some embodiments, the operation that the terminal device determines enablement or disablement of the second LP-WUS function based on the first configuration information and the second configuration information may include: when both the first configuration information and the second configuration information indicate enablement of the LP-WUS function, the terminal device enables the second LP-WUS function; and/or when both the first configuration information and the second configuration information indicate disablement of the LP-WUS function, the terminal device disables the second LP-WUS function. In this way, a CN paging problem caused by inconsistent configurations of the LP-WUS function provided by the first base station and the core network device for the terminal device is overcome.

Optionally, in some embodiments: when the first LP-WUS function is enabled, the terminal device monitors CN paging based on the LP-WUS; when the second LP-WUS function is enabled, the terminal device monitors RAN paging based on the LP-WUS; when the first LP-WUS function is disabled, the terminal device monitors CN paging based on the MR; when the second LP-WUS function is disabled, the terminal device monitors RAN paging based on the MR.

Optionally, in some embodiments, the LP-WUS is used to wake up the MR to monitor paging. That is, when the LP-WUS function is enabled, if the LR monitors the LP-WUS, the MR is woken up to monitor paging.

In other embodiments, the LP-WUS is used to indicate to wake up the MR or not to wake up the MR. For example, a value carried in an LP-WUS signal being equal to a first value indicates to wake up the MR; the value carried in the LP-WUS signal being equal to a second value indicates not to wake up the MR, where the first value is different from the second value.

It should be noted that in this embodiment of the present disclosure, enablement or disablement of the LP-WUS function may also be expressed as activation or deactivation of the LP-WUS function. Optionally, in some embodiments, enablement of the LP-WUS function means that the terminal device monitors the LP-WUS, and disablement of the LP-WUS function means that the terminal device does not monitor the LP-WUS. Optionally, in some embodiments, enablement of the LP-WUS function is a necessary but not sufficient condition for the terminal device to monitor the LP-WUS. That is, on the premise that the LP-WUS function is enabled, the terminal device further needs to combine it with an entry/exit condition of the LP-WUS of a current serving cell, and monitor the LP-WUS only when the entry condition of the LP-WUS is satisfied, otherwise not monitor the LP-WUS. In addition, another premise for the terminal device to monitor the LP-WUS in a cell is that the cell supports the LP-WUS.

Optionally, in some embodiments, the first configuration information indicates enablement of the first LP-WUS function, and/or the second configuration information indicates enablement of the second LP-WUS function. The operation that the terminal device determines enablement or disablement of the first LP-WUS function and/or the second LP-WUS function based on the first configuration information and/or the second configuration information may include: the terminal device determines enablement or disablement of the first LP-WUS function and/or the second LP-WUS function based on the first configuration information and/or the second configuration information, and/or based on whether signal reception quality of a serving cell is greater than or equal to a threshold, and/or whether the serving cell supports the LP-WUS.

Exemplarily, in some embodiments, the first configuration information indicates enablement of the first LP-WUS function, and the terminal device may determine enablement or disablement of the first LP-WUS function based on the first configuration information, and/or based on whether signal reception quality of the serving cell is greater than or equal to a threshold, and/or whether the serving cell supports the LP-WUS.

For example, when the first configuration information indicates enablement of the first LP-WUS function, and the signal reception quality of the serving cell of the terminal device is greater than or equal to a corresponding threshold and/or the serving cell supports the LP-WUS, the terminal device may monitor CN paging by enabling the first LP-WUS function.

For another example, when the first configuration information indicates enablement of the first LP-WUS function, and the signal reception quality of the serving cell of the terminal device is less than a corresponding threshold and/or the serving cell does not support the LP-WUS, the terminal device may monitor CN paging by disabling the first LP-WUS function, i.e., using the MR to monitor CN paging.

Exemplarily, in other embodiments, the second configuration information indicates enablement of the second LP-WUS function, and the terminal device may determine enablement or disablement of the second LP-WUS function based on the second configuration information, and/or based on whether signal reception quality of the serving cell is greater than or equal to a threshold, and/or whether the serving cell supports the LP-WUS.

For example, when the second configuration information indicates enablement of the second LP-WUS function, and the signal reception quality of the serving cell of the terminal device is greater than or equal to a corresponding threshold and/or the serving cell supports the LP-WUS, the terminal device may monitor RAN paging by enabling the second LP-WUS function.

For another example, when the second configuration information indicates enablement of the second LP-WUS function, and the signal reception quality of the serving cell of the terminal device is less than a corresponding threshold and/or the serving cell does not support the LP-WUS, the terminal device may monitor RAN paging by disabling the second LP-WUS function, and use the MR to monitor RAN paging.

Optionally, in some embodiments, the first configuration information indicates enablement of the first LP-WUS function, and the first indication information indicates enablement of the second LP-WUS function.

The operation that the terminal device determines enablement or disablement of the first LP-WUS function based on the first configuration information may include: the terminal device determines enablement or disablement of the first LP-WUS function based on the first configuration information, and/or based on whether signal reception quality of the serving cell is greater than or equal to a threshold, and/or whether the serving cell supports the LP-WUS.

The operation that the terminal device determines enablement or disablement of the second LP-WUS function based on the first indication information may include: the terminal device determines enablement or disablement of the second LP-WUS function based on the first indication information, and/or based on whether signal reception quality of the serving cell is greater than or equal to a threshold, and/or whether the serving cell supports the LP-WUS.

In this embodiment, even if the first configuration information indicates enablement of the first LP-WUS function, if the signal reception quality of the serving cell is less than the threshold and/or the serving cell does not support the LP-WUS, the terminal device still disables the first LP-WUS function. Certainly, if the first configuration information indicates enablement of the first LP-WUS function, and the signal reception quality of the serving cell is greater than or equal to the threshold and/or the serving cell supports the LP-WUS, the terminal device enables the first LP-WUS function.

Similarly, even if the first indication information indicates enablement of the second LP-WUS function, if the signal reception quality of the serving cell is less than the threshold and/or the serving cell does not support the LP-WUS, the terminal device still disables the second LP-WUS function. Certainly, if the first indication information indicates enablement of the second LP-WUS function, and the signal reception quality of the serving cell is greater than or equal to the threshold and/or the serving cell supports the LP-WUS, the terminal device enables the second LP-WUS function.

In this embodiment of the present disclosure, “first” in the “first LP-WUS function” and “second” in the “second LP-WUS function” only mean that paging monitored by the LP-WUS functions is different, which means that monitoring occasions for CN paging and RAN paging are different. Optionally, the monitoring occasions are related to cycle parameters transmitted by the core network device and the first base station to the terminal device.

In some embodiments, the terminal device may receive a first cycle parameter transmitted by the core network device and/or a second cycle parameter broadcast in a system message of a base station. The first cycle parameter and/or the second cycle parameter are/is used for monitoring of paging initiated by the core network device.

In some embodiments, the terminal device receives a third cycle parameter transmitted by the first base station. The third cycle parameter is used for monitoring of paging initiated by the first base station.

It may be understood that the first cycle parameter transmitted by the core network device and/or the second cycle parameter (such as a default DRX cycle) broadcast in the system message of the base station are/is used for monitoring of CN paging, and the third cycle parameter transmitted by the first base station is used for monitoring of RAN paging. In this way, a CN paging problem caused by inconsistent configurations of the LP-WUS function provided by the first base station and the core network device for the terminal device can be further optimized.

In this embodiment of the present disclosure, the base station that broadcasts the second cycle parameter via a system message is a base station of a cell where the terminal device currently camps, and the base station may be the first base station or not the first base station. The first cycle parameter transmitted by the core network device may also be understood as a first cycle parameter configured by the core network device. The third cycle parameter transmitted by the first base station may also be understood as a third cycle parameter configured by the first base station. Optionally, the first cycle parameter, the second cycle parameter, and the third cycle parameter may be discontinuous cycles for monitoring a paging channel, i.e., a DRX cycle and/or an eDRX cycle for the terminal device to receive paging.

It may be understood that the first cycle parameter and/or the second cycle parameter are/is used for monitoring of paging initiated by the core network device. Optionally, in some embodiments, monitoring of paging initiated by the core network device includes paging monitoring on a PO corresponding to paging initiated by the core network device (CN paging PO), and the first cycle parameter and/or the second cycle parameter are/is used for determining the PO corresponding to paging initiated by the core network device. Exemplarily, for determination of the PO, reference may be made to the determination method introduced above. In this embodiment of the present disclosure, the PO determination method is not limited to the PO determination method mentioned above. In short, the PO corresponding to paging initiated by the core network device can be obtained based on the first cycle parameter and/or the second cycle parameter.

It may be understood that the third cycle parameter is used for monitoring of paging initiated by the first base station. Optionally, in some embodiments, monitoring of paging initiated by the first base station includes paging monitoring on a PO corresponding to paging initiated by the first base station (RAN paging PO), and the third cycle parameter is used for determining the PO corresponding to paging initiated by the first base station. Exemplarily, for determination of the PO, reference may be made to the determination method introduced above. In this embodiment of the present disclosure, the PO determination method is not limited to the PO determination method mentioned above. In short, the PO corresponding to paging initiated by the first base station can be obtained based on the third cycle parameter.

It may be understood that the CN paging PO and the RAN paging PO may overlap. For an overlapping PO of the two, a processing manner of the terminal device may be the same as that for the CN paging PO or the same as that for the RAN paging PO.

That is, in an embodiment where the processing manner of the terminal device for the overlapping PO is the same as that for the CN paging PO, paging monitoring on the PO corresponding to paging initiated by the core network device (CN paging PO) includes paging monitoring on the overlapping PO; and paging monitoring on the PO corresponding to paging initiated by the first base station (RAN paging PO) does not include paging monitoring on the overlapping PO. That is, paging monitoring of the terminal device on the overlapping PO follows the first configuration information transmitted by the core network device to the terminal device. The terminal device may enable or disable the first LP-WUS function according to the first configuration information, and monitor paging on the CN paging PO (including the overlapping PO) based on this. The overlapping PO refers to an overlapping PO of the PO corresponding to paging initiated by the core network device and the PO corresponding to paging initiated by the first base station.

In this way, in a communication mechanism in which the core network device does not know configuration of the LP-WUS function of the terminal device by the first base station, the processing manner of the terminal device for the overlapping PO is the same as that for the CN paging PO, which can further optimize a CN paging problem caused by inconsistent configurations of the LP-WUS function provided by the first base station and the core network device for the terminal device.

In an embodiment where the processing manner of the terminal device for the overlapping PO is the same as that for the RAN paging PO, paging monitoring on the PO corresponding to paging initiated by the core network device (CN paging PO) does not include paging monitoring on the overlapping PO, and paging monitoring on the PO corresponding to paging initiated by the first base station (RAN paging PO) includes paging monitoring on the overlapping PO. That is, paging monitoring of the terminal device on the overlapping PO follows the second configuration information transmitted by the first base station to the terminal device. The terminal device may enable or disable the second LP-WUS function according to the second configuration information, and monitor paging on the RAN paging PO (including the overlapping PO) based on this.

In this way, in a communication mechanism in which the first base station does not know the configuration of the LP-WUS function provided by the core network device for of the terminal device, the processing manner of the terminal device for the overlapping PO is the same as that for the RAN paging PO, which can further optimize a CN paging problem caused by inconsistent configurations of the LP-WUS function provided by the first base station and the core network device for the terminal device.

Another embodiment of the present disclosure provides an information processing method. FIG. 4 is a second schematic flowchart of an implementation of the information processing method provided by the embodiment of the present disclosure. As shown in FIG. 4, the method includes the following operations 401 and 406:

Operation 401: A core network device transmits first configuration information to a terminal device.

The first configuration information is used to configure enablement or disablement of a first LP-WUS function. Monitoring of paging initiated by the core network device (CN paging) through the first LP-WUS function is LP-WUS based monitoring.

Optionally, in some embodiments, the terminal device may report LP-WUS-related capability information to the core network device. The core network device may receive the LP-WUS-related capability information reported by the terminal device. The LP-WUS-related capability information is used for determining the first configuration information. In this way, the first configuration information transmitted by the core network device to the terminal device is matched with the LP-WUS-related capability of the terminal device, thereby avoiding problems of increased power consumption or paging failure of the terminal device caused by inconsistency between the first configuration information and the LP-WUS-related capability of the terminal device.

Optionally, in some embodiments, the LP-WUS-related capability information includes but is not limited to at least one of the following: whether the LP-WUS function is supported; whether a power saving requirement exists; or a service delay requirement.

Exemplarily, in some embodiments, when the LP-WUS-related capability information reported by the terminal device indicates that the LP-WUS function is supported, the power saving requirement exists, and/or a low service delay requirement is met, the first configuration information transmitted by the core network device based on the LP-WUS-related capability information is configured to indicate enablement of the first LP-WUS function.

Exemplarily, in other embodiments, when the LP-WUS-related capability information reported by the terminal device indicates that the LP-WUS function is supported, the power saving requirement exists or does not exist, and a high service delay requirement is met, or when the LP-WUS-related capability information reported by the terminal device indicates that the LP-WUS function is not supported, the power saving requirement exists or does not exist, and a high or low service delay requirement is met, the first configuration information transmitted by the core network device based on the LP-WUS-related capability information is configured to indicate disablement of the first LP-WUS function.

In a possible implementation, the high service delay requirement may be represented by a third value, and the low service delay requirement may be represented by a fourth value, where the third value is different from the fourth value. In another possible implementation, the high service delay requirement may also be represented by a delay greater than or equal to a certain threshold, and the low service delay requirement may also be represented by a delay less than the threshold.

Optionally, the core network device may not only transmit the first configuration information to the terminal device, but also spread the first configuration information to one or more base stations within a paging range of the terminal device.

That is, in some embodiments, the core network device may transmit the first configuration information to one or more base stations, where the one or more base stations belong to a range for paging the terminal device. In this way, the one or more base stations within the paging range can consistently understand the configuration of the first LP-WUS function provided by the core network device for the terminal device, thereby solving a CN paging problem (such as CN paging failure or increased paging delay) caused by inconsistent understanding.

In a possible implementation, the core network device may transmit the first configuration information to some or all base stations of a Tracking Area (TA) where the terminal device is located. The Tracking Area where the terminal device is located may also be understood as a Tracking Area registered by the terminal device, and the Tracking Area may be used as a range for the core network device to page the terminal device.

In this embodiment of the present disclosure, no limitation is imposed on which message or messages in which the core network device carries the first configuration information to transmit the first configuration information to the one or more base stations within the range for paging the terminal device. In short, the core network device only needs to notify the one or more base stations within the paging range of the terminal device of the first configuration information through a communication interface (such as an NG interface) with the base stations.

Exemplarily, in some embodiments, the first configuration information transmitted to the one or more base stations is carried in at least one of the following messages: a paging message; an initial context setup request; a UE context release command; or a UE context modification request.

That is, the core network device may notify other base stations of the first configuration information based on at least one of the above four messages. It may be understood that if the first configuration information is carried in multiple pieces of the above four messages, it helps to increase the probability that the base stations obtain the first configuration information, thereby helping to further optimize the CN paging problem caused by inconsistent configurations of the first LP-WUS function of the terminal device.

Operation 402: The terminal device receives the first configuration information transmitted by the core network device.

The first configuration information is used to configure enablement or disablement of the first LP-WUS function. Monitoring of CN paging through the first LP-WUS function is LP-WUS based monitoring.

In this embodiment of the present disclosure, no limitation is imposed on a configuration manner of the core network device for the first LP-WUS function, and an explicit configuration manner or an implicit configuration manner may be adopted.

For the explicit configuration manner, in some embodiments, the first configuration information includes at least second indication information, and the second indication information is configured to indicate enablement or disablement of the first LP-WUS function.

Further, in some embodiments, the first configuration information further includes an LP-WUS-related parameter. That is, the first configuration information includes the second indication information and the LP-WUS-related parameter. The first configuration information may not include the LP-WUS-related parameter, and the LP-WUS-related parameter may be carried in other information different from the first configuration information.

For the implicit configuration manner, in some embodiments, the first configuration information includes an LP-WUS-related parameter, and the first configuration information is configured to indicate enablement of the first LP-WUS function. In this way, an objective of implicitly indicating enablement of the first LP-WUS function is achieved, and transmission resources are saved at the same time.

For the implicit configuration manner, in other embodiments, the first configuration information does not include an LP-WUS-related parameter, and the first configuration information is configured to indicate disablement of the first LP-WUS function. In this way, an objective of implicitly indicating disablement of the first LP-WUS function is achieved, and transmission resources are saved at the same time.

In this embodiment of the present disclosure, no limitation is imposed on the LP-WUS-related parameter, and in short, the parameter is related to an LP-WUS mechanism/function and is different from the second indication information.

Exemplarily, in some embodiments, the LP-WUS-related parameter includes LP-WUS subgrouping information, and the LP-WUS subgrouping information includes an LP-WUS subgroup to which the terminal device belongs. In this way, when an LP-WUS signal subsequently received by the terminal device indicates to wake up the LP-WUS subgroup to which the terminal device belongs, the terminal device may start/wake up the MR based on the LP-WUS to monitor CN paging. On the contrary, when the LP-WUS signal received by the terminal device indicates not to wake up the LP-WUS subgroup to which the terminal device belongs, the terminal device may not start/wake up the MR based on the LP-WUS, but continue to monitor the LP-WUS. In this way, grouping of terminal devices that start/wake up the MR in response to the LP-WUS helps to save power consumption of the terminal devices and save more power.

Optionally, in some embodiments, the core network device may also spread the first configuration information to one or more base stations within the paging range of the terminal device in the above explicit configuration manner or implicit configuration manner.

Operation 403: A first base station transmits second configuration information to the terminal device.

The second configuration information is used to configure enablement or disablement of a second LP-WUS function. Monitoring of paging initiated by the first base station (RAN paging) through the second LP-WUS function is LP-WUS based monitoring.

In this embodiment of the present disclosure, no limitation is imposed on a type of a message carrying the second configuration information, and the message may be of various types. Optionally, in some embodiments, the first base station may transmit second signaling to the terminal device. The second signaling is specific signaling for the terminal device, and the second signaling carries the second configuration information.

In this embodiment of the present disclosure, no limitation is imposed on the second signaling, and in short, the second signaling only needs to be specific signaling for the terminal device. Exemplarily, in some embodiments, the second signaling is an RRC connection release message (RRC Release message).

Exemplarily, in some embodiments, the RRC connection release message is configured to indicate entry into an RRC_INACTIVE state.

Optionally, the first base station may not only transmit the second configuration information to the terminal device, but also spread the second configuration information to one or more base stations within a paging range of the terminal device.

That is, in some embodiments, the first base station may transmit the second configuration information to one or more base stations, where the one or more base stations belong to a range for paging the terminal device. In this way, the one or more base stations within the paging range can consistently understand the configuration of the second LP-WUS function provided by the first base station for the terminal device, thereby solving a RAN paging problem (such as RAN paging failure or increased paging delay) caused by inconsistency.

In a possible implementation, the first base station may transmit the second configuration information to some or all base stations of a RAN-based Notification Area (RNA) where the terminal device is located. The RNA may be understood as a range for the first base station to page the terminal device.

In this embodiment of the present disclosure, no limitation is imposed on which message in which the first base station carries the second configuration information to transmit the second configuration information to the one or more base stations within the range for paging the terminal device. In short, the first base station only needs to notify the one or more base stations within the paging range of the terminal device of the second configuration information through a communication interface (such as an Xn interface) with other base stations.

Exemplarily, in some embodiments, the second configuration information transmitted to the one or more base stations is carried in a paging message.

Operation 404: The terminal device receives the second configuration information transmitted by the first base station.

In some embodiments, the terminal device may receive the second signaling transmitted by the first base station. The second signaling is specific signaling for the terminal device, and the second signaling carries the second configuration information. Further, in some embodiments, the second signaling is an RRC connection release message. Exemplarily, in some embodiments, the RRC connection release message is configured to indicate entry into an RRC_INACTIVE state.

Operation 405: The terminal device monitors paging initiated by the core network device (CN paging) based on the first configuration information.

In this embodiment of the present disclosure, the terminal device may monitor CN paging only based on the first configuration information, or monitor CN paging based on the first configuration information and other conditions. Optionally, in some embodiments, enabling the first LP-WUS function is a necessary but not sufficient condition for the terminal device to monitor the LP-WUS. That is, when the first configuration information configures the first LP-WUS function of the terminal device as enablement of the LP-WUS function, the terminal device may need to activate the LP-WUS function or may not activate the LP-WUS function.

Exemplarily, in some embodiments, when the first configuration information indicates enablement of the first LP-WUS function, the operation of monitoring, by the terminal device, paging initiated by the core network device based on the first configuration information may include that: the terminal device determines whether to monitor paging initiated by the core network device by enabling the first LP-WUS function based on the first configuration information, and/or based on whether signal reception quality of a serving cell is greater than or equal to a threshold and/or whether the serving cell supports the LP-WUS.

For example, when the first configuration information indicates enablement of the first LP-WUS function, and the signal reception quality of the serving cell of the terminal device is greater than or equal to a corresponding threshold and/or the serving cell supports the LP-WUS, the terminal device may monitor CN paging by enabling the first LP-WUS function.

For another example, when the first configuration information indicates enablement of the first LP-WUS function, and the signal reception quality of the serving cell of the terminal device is less than a corresponding threshold and/or the serving cell does not support the LP-WUS, the terminal device may monitor CN paging by disabling the first LP-WUS function.

In this embodiment of the present disclosure, no limitation is imposed on a type of a parameter representing the signal reception quality of the serving cell, and the parameter may be Reference Signal Receiving Power (RSRP), Signal to Interference plus Noise Ratio (SINR), Bit Error Rate, Block Error Rate (BLER), or the like.

Operation 406: The terminal device monitors paging initiated by the first base station (RAN paging) based on the second configuration information.

Similarly, the terminal device may monitor RAN paging only based on the second configuration information, or monitor RAN paging based on the second configuration information and other conditions. Optionally, in some embodiments, enabling the second LP-WUS function is a necessary but not sufficient condition for the terminal device to monitor the LP-WUS.

Exemplarily, in some embodiments, when the second configuration information indicates enablement of the second LP-WUS function, the operation of monitoring, by the terminal device, paging initiated by the first base station based on the second configuration information may include that: the terminal device determines whether to monitor paging initiated by the first base station by enabling the second LP-WUS function based on the second configuration information, and/or based on whether signal reception quality of a serving cell is greater than or equal to a threshold and/or whether the serving cell supports the LP-WUS.

For determining whether to monitor RAN paging by enabling the second LP-WUS function based on these conditions, reference may be made to the embodiment of monitoring CN paging when the first configuration information indicates enablement of the first LP-WUS function.

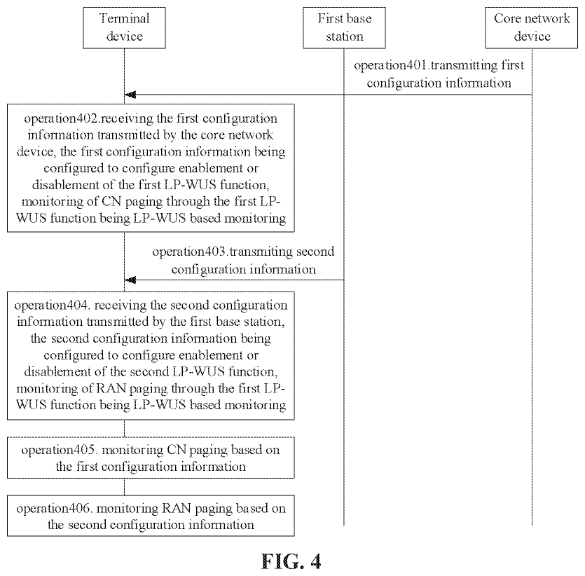

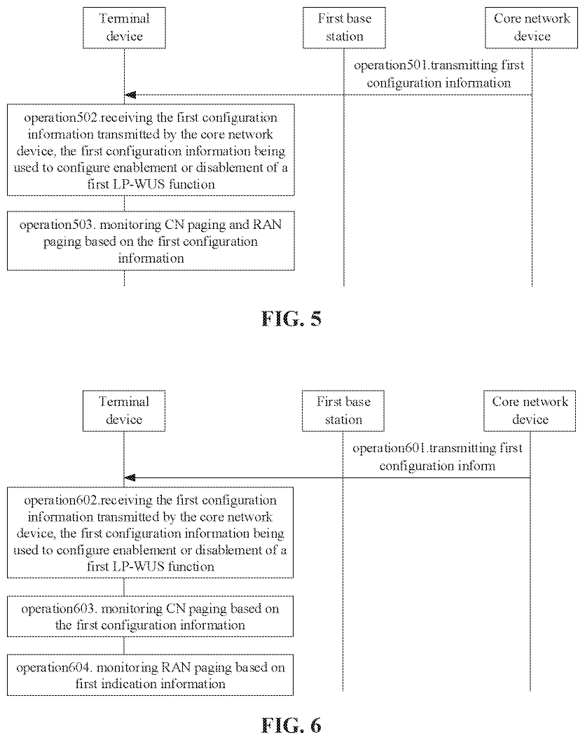

An embodiment of the present disclosure provides an information processing method. FIG. 5 is a third schematic flowchart of an implementation of the information processing method provided by the embodiment of the present disclosure. As shown in FIG. 5, the method includes the following operations 501 and 503:

Operation 501: A core network device transmits first configuration information to a terminal device.

Operation 502: The terminal device receives the first configuration information transmitted by the core network device.

The first configuration information is used to configure enablement or disablement of a first LP-WUS function.

Operation 503: The terminal device monitors paging initiated by the core network device (CN paging) and paging initiated by the first base station (RAN paging) based on the first configuration information.

That is, when only the core network device configures enablement or disablement of the LP-WUS function for the terminal device, the terminal device adopts a same monitoring policy for CN paging and RAN paging, i.e., the terminal device monitors CN paging and RAN paging based on the first configuration information.

In other embodiments, when only the core network device configures enablement or disablement of the LP-WUS function for the terminal device, the monitoring policies adopted by the terminal device for CN paging and RAN paging may also be different, i.e., the terminal device monitors CN paging based on the first configuration information, but does not monitor RAN paging based on the first configuration information. For example, the terminal device monitors RAN paging based on operation 604 of the following embodiment.

An embodiment of the present disclosure provides an information processing method. FIG. 6 is a fourth schematic flowchart of an implementation of the information processing method provided by the embodiment of the present disclosure. As shown in FIG. 6, the method includes the following operations 601 and 604:

Operation 601: A core network device transmits first configuration information to a terminal device.

Operation 602: The terminal device receives the first configuration information transmitted by the core network device.

The first configuration information is used to configure enablement or disablement of a first LP-WUS function.

Operation 603: The terminal device monitors paging initiated by the core network device (CN paging) based on the first configuration information.

Operation 604: The terminal device monitors paging initiated by a first base station (RAN paging) based on first indication information.

The first indication information is configured to indicate enablement or disablement of the second LP-WUS function.

Optionally, in this embodiment of the present disclosure, the first indication information may be predefined (e.g., to enable or disable the second LP-WUS function), or the first indication information may also be from a broadcast message transmitted by a base station, or the first indication information may also be from first signaling transmitted by a base station, where the first signaling is specific signaling for the terminal device.

In a possible implementation, the base station that broadcasts the first indication information via a broadcast message or transmits the first indication information via first signaling is a serving base station of the terminal device, and the base station may be the first base station or another base station different from the first base station.

In this embodiment of the present disclosure, the first signaling may be various types of specific signaling for the terminal device, and is not limited to an RRC connection release message.

Similarly, in operation 604, the terminal device may monitor RAN paging only based on the first indication information, or monitor RAN paging based on the first indication information and other conditions. Optionally, in some embodiments, enabling the second LP-WUS function is a necessary but not sufficient condition for the terminal device to monitor the LP-WUS.

Exemplarily, in some embodiments, the terminal device may determine whether to monitor paging initiated by the first base station by enabling the second LP-WUS function based on the first indication information, and/or based on whether signal reception quality of a serving cell is greater than or equal to a threshold and/or whether the serving cell supports the LP-WUS.

For determining whether to monitor RAN paging by enabling the second LP-WUS function based on these conditions, reference may be made to the embodiment of monitoring CN paging when the first configuration information indicates enablement of the first LP-WUS function.

Optionally, in any one of the above embodiments, the terminal device is in an RRC_INACTIVE state when monitoring the paging initiated by the core network device and/or paging initiated by the first base station.

For the terminal device in an RRC_IDLE state, optionally, in other embodiments, the terminal device may monitor paging initiated by the core network device and paging initiated by the first base station based on the first configuration information.

The above embodiments describe possible implementations of how to optimize CN paging performance (including shortening a CN paging delay and reducing the number of CN paging failures). For how to optimize CN paging performance, the present disclosure further provides another possible implementation, and reference may be made to the description of the following embodiment for details.

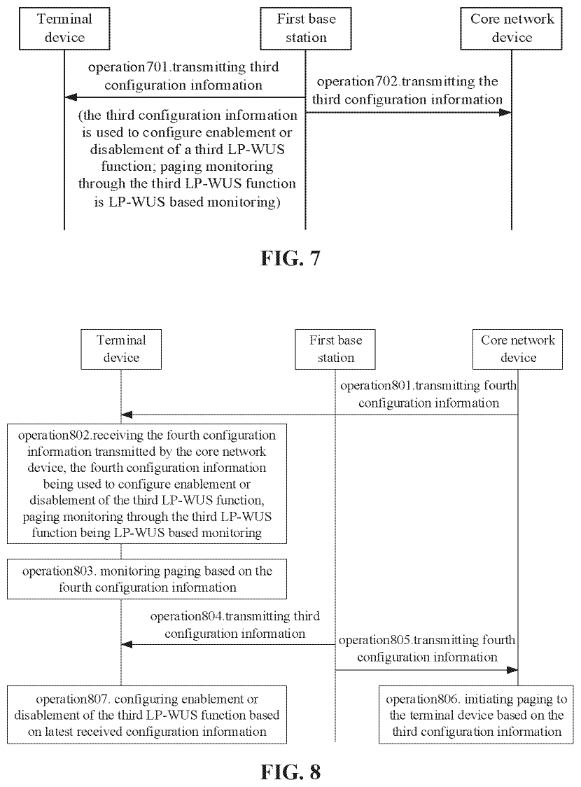

Another embodiment of the present disclosure provides an information processing method. FIG. 7 is a fifth schematic flowchart of an implementation of the information processing method provided by the embodiment of the present disclosure. As shown in FIG. 7, the method includes the following operations 701 and 702:

Operation 701: A first base station transmits third configuration information to a terminal device.

Operation 702: The first base station transmits the third configuration information to a core network device.

The third configuration information is used to configure enablement or disablement of a third LP-WUS function. Monitoring of paging through the third LP-WUS function is LP-WUS based monitoring.

It may be understood that in this embodiment of the present disclosure, the first base station notifies the core network device of the third configuration information configured for the terminal device. In this way, the terminal device, the first base station and the core network device can consistently understand an enablement or disablement state of the LP-WUS function of the terminal device, thereby overcoming a CN paging problem caused by inconsistent understanding of the enablement or disablement state of the LP-WUS function of the terminal device, i.e., helping to shorten a CN paging delay or reduce the number of CN paging failures.

Further optional implementations of the above operations and related terms are described below respectively.

In operation 701, the first base station transmits third configuration information to the terminal device.

In this embodiment of the present disclosure, no limitation is imposed on a type of a message carrying the third configuration information, and the message may be of various types. Optionally, in some embodiments, the first base station may transmit third signaling to the terminal device. The third signaling is specific signaling for the terminal device, and the third signaling carries the third configuration information.

In this embodiment of the present disclosure, no limitation is imposed on the third signaling, and in short, the third signaling only needs to be specific signaling for the terminal device. Exemplarily, in some embodiments, the third signaling is an RRC connection release message.

Exemplarily, in some embodiments, the RRC connection release message is configured to indicate entry into an RRC_INACTIVE state; or the RRC connection release message is configured to indicate entry into an RRC_IDLE state.

That is, the third configuration information may be configured when the first base station releases the terminal device to the RRC_IDLE state or the RRC_INACTIVE state, or the third configuration information may only be configured when the first base station releases the terminal device to the RRC_INACTIVE state.

In operation 702, the first base station transmits the third configuration information to the core network device.

The third configuration information is used to configure enablement or disablement of a third LP-WUS function. Monitoring of paging through the third LP-WUS function is LP-WUS based monitoring. Monitoring of paging is not distinguished between CN paging and RAN paging. Monitoring of paging includes monitoring of CN paging and RAN paging. That is, monitoring policies for CN paging and RAN paging are the same, and paging is monitored based on the third configuration information.

In this embodiment of the present disclosure, for a solution in which the first base station transmits the third configuration information to the core network device, no limitation is imposed on a type of a message carrying the third configuration information, and the message may be of various types. In short, the first base station only needs to notify the core network device of the third configuration information through a communication interface (such as an NG interface) with the core network device.

Exemplarily, in some embodiments, the third configuration information is carried in an NG message. In a possible implementation, the first base station may implement operation 702 as follows: the third configuration information transmitted by the first base station to the core network device is carried in at least one of the following messages: a UE context release request; a UE context release complete; an RRC inactive transition report; or a UE context suspend request.

That is, the first base station may notify the core network device of the third configuration information based on at least one of the above four messages. It may be understood that when the third configuration information is carried in multiple ones of the above four messages, it helps to increase the probability that the core network device obtains the third configuration information, thereby helping to further optimize the CN paging problem caused by inconsistent configuration of the third LP-WUS function of the terminal device.

Optionally, the first base station may not only transmit the third configuration information to the terminal device and the core network device, but also spread the third configuration information to one or more base stations within a paging range of the terminal device.

That is, in some embodiments, the first base station may transmit the third configuration information to one or more base stations, where the one or more base stations belong to a range for paging the terminal device. In this way, the one or more base stations within the paging range can consistently understand configuration of the third LP-WUS function provided by the first base station for the terminal device, thereby solving a CN paging or RAN paging problem (such as paging failure or increased paging delay) caused by inconsistency.

In a possible implementation, the first base station may transmit the third configuration information to some or all base stations of an RNA where the terminal device is located. The RNA may be understood as a range for the first base station to page the terminal device.

In this embodiment of the present disclosure, no limitation is imposed on which message in which the first base station carries the third configuration information to transmit the third configuration information to the one or more base stations within the range for paging the terminal device. In short, the first base station only needs to notify the one or more base stations within the paging range of the terminal device of the third configuration information through a communication interface (such as an Xn interface) with other base stations.

Exemplarily, in some embodiments, the third configuration information transmitted to the one or more base stations is carried in a paging message.

Another embodiment of the present disclosure provides an information processing method. FIG. 8 is a sixth schematic flowchart of an implementation of the information processing method provided by the embodiment of the present disclosure. As shown in FIG. 8, the method includes the following operations 801 to 807:

Operation 801: A core network device transmits fourth configuration information to a terminal device.

The fourth configuration information is used to configure enablement or disablement of a third LP-WUS function. Monitoring of paging by the third LP-WUS function is LP-WUS based monitoring.

In some embodiments, the method may further include: the terminal device reports LP-WUS-related capability information to the core network device; the core network device receives the LP-WUS-related capability information reported by the terminal device; and the LP-WUS-related capability information is used for determining the fourth configuration information.

For determination of the fourth configuration information, reference may be made to determination of the first configuration information in the above embodiment, and details are not described herein again.

In this embodiment of the present disclosure, configuration of the third LP-WUS function provided by the core network device is the same as configuration of the first LP-WUS function provided by the core network device in the above embodiment, and therefore details are not described herein again.

In some embodiments, the fourth configuration information includes at least third indication information, and the third indication information is configured to indicate enablement or disablement of the third LP-WUS function.

Further, in some embodiments, the fourth configuration information further includes an LP-WUS-related parameter.

Optionally, in other embodiments, the fourth configuration information includes an LP-WUS-related parameter, the fourth configuration information does not include the third indication information, the third indication information is configured to indicate enablement or disablement of the third LP-WUS function, and the fourth configuration information is configured to indicate enablement of the third LP-WUS function.

Optionally, in other embodiments, the fourth configuration information does not include an LP-WUS-related parameter or the third indication information, the third indication information is configured to indicate enablement or disablement of the third LP-WUS function, and the fourth configuration information is configured to indicate disablement of the third LP-WUS function.

Exemplarily, in some embodiments, the LP-WUS-related parameter includes LP-WUS subgrouping information, and the LP-WUS subgrouping information includes an LP-WUS subgroup to which the terminal device belongs. It may be understood that each terminal device has its own LP-WUS subgroup, so that when a network device (such as the first base station or the core network device) indicates, via an LP-WUS signal, to wake up terminal devices of which one or more LP-WUS subgroups, the terminal devices belonging to the one or more LP-WUS subgroups all respond to the received LP-WUS signal, while terminal devices of other LP-WUS subgroups do not respond to the LP-WUS signal, thereby helping to save power consumption of the terminal devices and achieve the objective of saving more power.

Operation 802: The terminal device receives the fourth configuration information transmitted by the core network device.

The fourth configuration information is used to configure enablement or disablement of the third LP-WUS function. Paging monitoring through the third LP-WUS function is LP-WUS based monitoring.

Operation 803: The terminal device monitors paging based on the fourth configuration information.

It may be understood that when the terminal device only receives the fourth configuration information transmitted by the core network device, the terminal device may monitor paging (including RAN paging and CN paging) based on the fourth configuration information. In a possible implementation, before the core network device receives third configuration information transmitted by the first base station, the core network device may initiate paging to the terminal device based on the fourth configuration information.

In some embodiments, when the terminal device receives the fourth configuration information transmitted by the core network device and does not receive the third configuration information transmitted by the first base station, the terminal device may configure enablement or disablement of the third LP-WUS function based on the fourth configuration information.

Operation 804: The first base station transmits third configuration information to the terminal device.

Operation 805: The first base station transmits third configuration information to the core network device.

Operation 806: The core network device initiates paging to the terminal device based on the third configuration information.

It may be understood that even if the core network device transmits the fourth configuration information to the terminal device, if the first base station transmits the third configuration information configured for the terminal device to the core network device, the core network device may subsequently initiate paging to the terminal device based on the third configuration information. In this way, a CN paging problem caused by inconsistent configurations of the LP-WUS function provided by the first base station and the core network device for the terminal device can be overcome, thereby helping to improve communication service quality.

Optionally, the core network device may also spread the third configuration information to one or more base stations within a paging range of the terminal device.

That is, in some embodiments, the core network device may transmit the third configuration information to one or more base stations, where the one or more base stations belong to a range for paging the terminal device.

In a possible implementation, the core network device may transmit the third configuration information to some or all base stations of a Tracking Area (TA) where the terminal device is located. The Tracking Area where the terminal device is located may also be understood as a Tracking Area registered by the terminal device, and the Tracking Area may be used as a range for the core network device to page the terminal device.

In this embodiment of the present disclosure, no limitation is imposed on which message or messages in which the core network device carries the third configuration information to transmit the third configuration information to the one or more base stations within the range for paging the terminal device. In short, the core network device only needs to notify the one or more base stations within the paging range of the terminal device of the third configuration information through a communication interface (such as an NG interface) with the base stations.

Exemplarily, in some embodiments, the third configuration information transmitted to the one or more base stations is carried in at least one of the following messages: a paging message; an initial context setup request; a UE context release command; or a UE context modification request.

Operation 807: When the terminal device receives the third configuration information transmitted by the first base station and the fourth configuration information transmitted by the core network device, the terminal device configures enablement or disablement of the third LP-WUS function based on latest received configuration information, so as to monitor paging initiated by the first base station and/or the core network device.

The latest received configuration information is the third configuration information or the fourth configuration information.

It may be understood that the reason why the configuration information received last time by the terminal device may also be the fourth configuration information configured by the core network device is that after the first base station configures the third configuration information for the terminal device, the core network device may also change the configuration of the third LP-WUS function for the terminal device.

In other embodiments, when the terminal device receives the third configuration information transmitted by the first base station and the fourth configuration information transmitted by the core network device, the terminal device may configure enablement or disablement of the third LP-WUS function based on the third configuration information, so as to monitor paging initiated by the first base station and/or the core network device.

It may be understood that when the terminal device receives the third configuration information transmitted by the first base station and the fourth configuration information transmitted by the core network device, since the first base station also notifies the core network device of the third configuration information transmitted to the terminal device, a CN paging problem caused by inconsistent configurations of the LP-WUS function provided by the first base station and the core network device for the terminal device can be avoided no matter whether the terminal device configures enablement or disablement of the third LP-WUS function based on the configuration information received last time or based on the third configuration information transmitted by the first base station.

In this embodiment of the present disclosure, the terminal device may monitor paging only based on the third configuration information or the fourth configuration information, or monitor paging based on the third configuration information or the fourth configuration information and other conditions. Optionally, in some embodiments, enabling the third LP-WUS function is a necessary but not sufficient condition for the terminal device to monitor the LP-WUS. That is, when the third configuration information or the fourth configuration information configures the third LP-WUS function of the terminal device as enablement of the LP-WUS function, the terminal device may need to activate the LP-WUS function or may not activate the LP-WUS function.

Exemplarily, in some embodiments, when the third configuration information or the fourth configuration information indicates enablement of the third LP-WUS function, the operation of configuring, by the terminal device, enablement or disablement of the third LP-WUS function based on the third configuration information or the fourth configuration information may include that: the terminal device determines whether to enable the third LP-WUS function based on the third configuration information or the fourth configuration information, and/or based on whether signal reception quality of a serving cell is greater than or equal to a threshold and/or whether the serving cell supports the LP-WUS.

Optionally, in some embodiments, a connection state of the terminal device for configuring enablement or disablement of the third LP-WUS function may be an RRC_IDLE state or an RRC_INACTIVE state.

An exemplary application of the embodiment of the present disclosure in an actual application scenario is described below.

### Embodiment 1

LP-WUS function enablement/disablement indication information configured for a UE by a core network (i.e., a core network device) and an anchor base station (i.e., a first base station) are respectively configured to control whether the UE determines, for a CN paging PO (including an overlapping PO of CN paging and RAN paging) and a RAN paging PO, whether to monitor the PO based on reception of the LP-WUS.

### Detailed Implementation Procedures:

1. The UE reports LP-WUS related capabilities to the core network, and then receives UE-specific LP-WUS related configuration information (i.e., one example of the first configuration information) from the core network. The LP-WUS configuration information includes one or more of the following:
LP-WUS function enable/disable indication information; and
LP-WUS subgrouping information.

The LP-WUS function enable/disable indication information may also be expressed as LP-WUS function activation/deactivation indication information.

The LP-WUS function enable/disable indication information may be indicated explicitly or implicitly (e.g., if the core network configures an LP-WUS related parameter for the UE, the LP-WUS function of the UE is considered enabled; if the core network does not configure an LP-WUS related parameter for the UE, the LP-WUS function of the UE is considered disabled).

2. The UE receives LP-WUS function enable/disable indication information configured for the UE (i.e., one example of the second configuration information) from an anchor base station (i.e., one example of the first base station). The LP-WUS function enable/disable indication information is carried in UE-specific signaling (e.g., an RRC Release message).

Further, the LP-WUS function enable/disable indication information may be configured only when the anchor base station releases the UE to the RRC_INACTIVE state.

3. The UE in an RRC non-connected state determines whether to enable the LP-WUS function based on configuration from the network (the core network and/or anchor base station):

a) For the UE in the RRC_IDLE state, the UE enables or disables the LP-WUS function according to the configuration from the core network.

b) For the UE in the RRC_INACTIVE state:

b1) If only the core network configures an indication for enabling/disabling the LP-WUS function for the UE:

Method 1: The UE enables or disables the LP-WUS function according to the configuration from the core network, i.e.:

When the core network indicates enablement of the LP-WUS function, the UE adopts the same monitoring policy for CN paging and RAN paging, i.e., determining whether to wake up the MR of the UE to monitor paging according to LP-WUS reception;

When the core network indicates disablement of the LP-WUS function, the UE does not monitor the LP-WUS, and the MR of the UE directly monitors paging (including CN paging and RAN paging) on its own PO.

Method 2: The UE determines whether to enable or disable the LP-WUS function for monitoring CN paging according to the configuration from the core network, and determines whether to enable or disable the LP-WUS function for monitoring RAN paging according to first LP-WUS function enable/disable information. The first LP-WUS function enable/disable information may be determined in a predefined manner by a protocol, or configured by the network via broadcast or UE-specific signaling.

b2) If both the core network and the anchor base station configure an LP-WUS function enable/disable indication for the UE:

The UE determines whether to enable or disable the LP-WUS function for monitoring CN paging according to the configuration from the core network, and determines whether to enable or disable the LP-WUS function for monitoring RAN paging according to the configuration from the anchor base station.

It should be noted that, in Embodiment 1, the UE distinguishes the above CN paging and RAN paging not based on the source of the paging message (from the core network or from a base station), but based on a CN paging PO and an RAN paging PO. A PO calculated according to (e) DRX parameters configured by the CN (i.e., core network) (i.e., first cycle parameter) and/or a default DRX cycle broadcast by system information (i.e., second cycle parameter) is a CN paging PO. A PO calculated according to (e) DRX cycle configured by the RAN (i.e., base station) (i.e., third cycle parameter) is a RAN paging PO. For an overlapping PO of CN paging and RAN paging, the UE processes it in the same manner as a CN paging PO.

It should also be noted that the following understandings of “LP-WUS function enable/disable” may exist in embodiments of the present disclosure:

Enablement of the LP-WUS function means that a UE monitors an LP-WUS, and disablement of the LP-WUS function means that the UE does not monitor the LP-WUS.

Enablement of the LP-WUS function is a necessary but not sufficient condition for a UE to monitor an LP-WUS. On the premise that the LP-WUS function is enabled, the UE further needs to combine it with an LP-WUS enter/leave criteria of a current cell, and monitors the LP-WUS only when the LP-WUS enter condition is satisfied; otherwise, the UE does not monitor the LP-WUS.

In addition, another prerequisite for the UE to monitor the LP-WUS in a cell is that the cell supports the LP-WUS.

### Embodiment 2

When a anchor base station configures LP-WUS function enable/disable indication information for a UE, the anchor base station notifies a core network of the configured LP-WUS function enable/disable indication information. The UE determines whether to enable/disable the LP-WUS function according to the latest received LP-WUS function enable/disable indication or the LP-WUS function enable/disable indication from the anchor base station.

### Detailed Implementation Procedures:

1. The UE reports LP-WUS related capabilities to the core network, and then receives UE-specific LP-WUS related configuration information (i.e., one example of fourth configuration information) from the core network, including LP-WUS function enable/disable indication information indicated explicitly or implicitly, which is the same as Operation 1 of Embodiment 1.

2. The UE receives LP-WUS function enable/disable indication information configured for the UE (i.e., one example of third configuration information) from the anchor base station. The LP-WUS function enable/disable indication information is carried in UE-specific signaling (e.g., an RRC Release message).

Further, the LP-WUS function enable/disable indication information may be configured when the anchor base station releases the UE to the RRC_IDLE state or the RRC_INACTIVE state, or the LP-WUS function enable/disable indication information may be configured only when the anchor base station releases the UE to the RRC_INACTIVE state.

3. The anchor base station notifies the core network of the LP-WUS function enable/disable indication information configured for the UE (so that the UE, the anchor base station and the core network have a consistent understanding of the LP-WUS function enable/disable state of the UE).

4. The UE in an RRC non-connected state determines whether to enable the LP-WUS function based on configuration from the network (core network and/or anchor base station):
a) If only the core network configures LP-WUS function enable/disable indication for the UE, the UE enables or disables the LP-WUS function according to the configuration from the core network;
b) If both the core network and the anchor base station transmit LP-WUS function enable/disable indication to the UE:

Method 1: The UE determines whether to enable the LP-WUS function according to the latest received LP-WUS function enable or disable indication, where the latest received LP-WUS function enable or disable indication is from the core network or the anchor base station.

Method 2: The UE determines whether to enable the LP-WUS function according to the LP-WUS function enable or disable indication configured by the anchor base station in Operation 2.

### Embodiment 3

A core network and a base station exchange LP-WUS function enable/disable indication information configured for a UE.

### Specifically:

1. The core network transmits LP-WUS function enable/disable indication information configured for a UE to the base station through an NG interface, i.e., introducing the LP-WUS function enable/disable indication information for the UE into an NG message between the core network and the base station. The LP-WUS function enable/disable indication information of the UE may be carried in the following messages (but not limited thereto):
Paging message (PAGING);
Initial Context Setup Request, e.g., carried in Core Network Assistance Information which is an IE;
UE Context Release Command; and
UE Context Modification Request, e.g., carried in the Core Network Assistance Information which is an IE.

2. (Only applicable to Embodiment 2) The base station transmits LP-WUS function enable/disable indication information configured by the base station for a UE to the core network through an NG interface, i.e., introducing the LP-WUS function enable/disable indication information for the UE into an NG message between the base station and the core network. The LP-WUS function enable/disable indication information for the UE may be carried in the following messages (but not limited thereto):
UE Context Release Request;
UE Context Release Complete;
RRC Inactive Transition Report; and
UE Context Suspend Request.

### Embodiment 4

Base stations exchange LP-WUS function enable/disable indication information for a UE.

### Specifically:

1. An anchor base station transmits LP-WUS function enable/disable indication information configured for a UE to a non-anchor base station through an Xn interface, i.e., introducing the LP-WUS function enable/disable indication information for the UE into an Xn message between base stations. For example, the LP-WUS function enable/disable indication information for the UE may be carried in a RAN PAGING message.

It should be noted that the LP-WUS function enable/disable indication information mentioned in the present disclosure is applicable when the UE is in an RRC non-connected state (including the RRC_IDLE state and the RRC_INACTIVE state).

In embodiments of the present disclosure, a paging method based on a low-power wake-up signal is provided. By using the method, when both a core network and a base station configure LP-WUS enable/disable indication information for a UE, the UE, the base station and the core network can reach a consistent understanding of the paging monitoring behavior of the UE, thereby effectively avoiding unnecessary system resource waste, paging delay and even paging failure caused by inconsistent understanding of the paging monitoring behavior of the UE.

The preferred embodiments of the present disclosure are described in detail above with reference to the accompanying drawings. However, the present disclosure is not limited to the specific details in the foregoing embodiments. Within the scope of the technical concept of the present disclosure, many simple modifications may be made to the technical solutions of the present disclosure, and these simple modifications all fall within the protection scope of the present disclosure. For example, various specific technical features described in the foregoing specific embodiments may be combined in any appropriate manner without contradiction. To avoid unnecessary repetition, the present disclosure does not separately explain various possible combinations. For another example, various different embodiments of the present disclosure may also be combined arbitrarily as long as they do not violate the idea of the present disclosure, and such combinations shall also be regarded as the content in the present disclosure. For another example, on the premise that no conflict occurs, each embodiment described in the present disclosure and/or technical features in each embodiment may be arbitrarily combined with those in the prior art, and a technical solution obtained after such combination shall also fall within the protection scope of the present disclosure.

It should also be understood that, in various method embodiments of the present disclosure, the sequence numbers of the foregoing processes do not mean the execution sequence. The execution sequence of each process shall be determined by its function and internal logic, and shall not constitute any limitation on the implementation process of the embodiments of the present disclosure. In addition, in the embodiments of the present disclosure, the terms “downlink”, “uplink” and “sidelink” are used to indicate transmission directions of signals or data, where “downlink” is used to indicate that the transmission direction of signals or data is a first direction from a station to a UE in a cell, “uplink” is used to indicate that the transmission direction of signals or data is a second direction from a UE in a cell to a station, and “sidelink” is used to indicate that the transmission direction of signals or data is a third direction from UE 1 to UE 2. For example, a “downlink signal” indicates that the transmission direction of the signal is the first direction. In addition, in the embodiments of the present disclosure, the term “and/or” is only an association relationship describing associated objects, indicating that three relationships may exist. Specifically, A and/or B may indicate the following three cases: A exists alone, A and B exist simultaneously, and B exists alone. In addition, the character “/” herein generally indicates that the associated objects are in an “or” relationship.

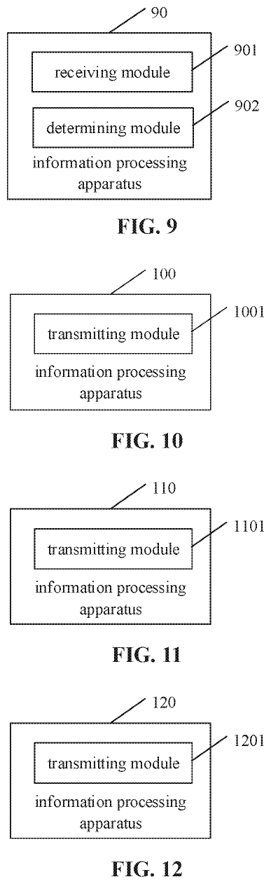

FIG. 9 is a first structural schematic diagram of an information processing apparatus according to an embodiment of the present disclosure. The information processing apparatus is implemented by a terminal device. As shown in FIG. 9, an information processing apparatus 90 includes:
a receiving module 901, configured to receive first configuration information from a core network device and/or second configuration information from a first base station;
a determining module 902, configured to determine enablement or disablement of a first LP-WUS function and/or a second LP-WUS function based on the first configuration information and/or the second configuration information.

The first LP-WUS function is used for monitoring paging initiated by the core network device (CN paging); and the second LP-WUS function is used for monitoring paging RAN paging initiated by the first base station.

In some embodiments, the receiving module 901 is configured to receive the first configuration information and the second configuration information when the terminal device is in an RRC_INACTIVE state; and the determining module 902 is configured to determine enablement or disablement of the first LP-WUS function based on the first configuration information, and determine enablement or disablement of the second LP-WUS function based on the second configuration information.

In some embodiments, the receiving module 901 is configured to receive the first configuration information when the terminal device is in an RRC_INACTIVE state; and the determining module 902 is configured to determine enablement or disablement of the first LP-WUS function and the second LP-WUS function based on the first configuration information.

In some embodiments, the receiving module 901 is configured to receive the first configuration information when the terminal device is in an RRC_INACTIVE state; the determining module 902 is configured to determine enablement or disablement of the first LP-WUS function based on the first configuration information; the determining module 902 is further configured to determine enablement or disablement of the second LP-WUS function based on first indication information when the terminal device is in an RRC_INACTIVE state. The first indication information is predefined, or the first indication information is from a broadcast message transmitted by a base station, or the first indication information is from first signaling transmitted by a base station, where the first signaling is specific signaling of the terminal device.

In some embodiments, the receiving module 901 is configured to receive the first configuration information when the terminal device is in an RRC_INACTIVE state; the determining module 902 is configured to determine enablement or disablement of the first LP-WUS function based on the first configuration information; the determining module 902 is further configured to disable the second LP-WUS function when the terminal device is in an RRC_INACTIVE state.

In some embodiments, the receiving module 901 is further configured to receive first cycle parameter from the core network device and/or second cycle parameter broadcast by system information of a base station; the first cycle parameter and/or the second cycle parameter are/is used for monitoring paging initiated by the core network device.

In some embodiments, the monitoring of paging initiated by the core network device includes paging monitoring on a PO corresponding to the paging initiated by the core network device, and the first cycle parameter and/or the second cycle parameter are/is used for determining the PO corresponding to the paging initiated by the core network device.

In some embodiments, the receiving module 901 is further configured to receive third cycle parameter transmitted by the first base station; the third cycle parameter is used for monitoring paging initiated by the first base station.

In some embodiments, the monitoring of paging initiated by the first base station includes paging monitoring on a PO corresponding to the paging initiated by the first base station, and the third cycle parameter is used for determining the PO corresponding to the paging initiated by the first base station.

In some embodiments, the paging monitoring on the PO corresponding to the paging initiated by the core network device includes paging monitoring on an overlapping PO, and the paging monitoring on the PO corresponding to the paging initiated by the first base station does not include paging monitoring on the overlapping PO; the overlapping PO is a PO where the PO corresponding to the paging initiated by the core network device overlaps with the PO corresponding to the paging initiated by the first base station.

In some embodiments, the first configuration information includes at least second indication information, and the second indication information is used for indicating enablement or disablement of the first LP-WUS function.

Further, in some embodiments, the first configuration information further includes an LP-WUS related parameter.

In other embodiments, the first configuration information includes an LP-WUS related parameter, and does not include the second indication information; the second indication information is used for indicating enablement or disablement of the first LP-WUS function.

Accordingly, optionally, in some embodiments, the first configuration information is used for indicating enablement of the first LP-WUS function.

In still other embodiments, the first configuration information does not include an LP-WUS related parameter or the second indication information; the second indication information is used for indicating enablement or disablement of the first LP-WUS function.

Optionally, in some embodiments, the first configuration information is used for indicating disablement of the first LP-WUS function.

Exemplarily, in some embodiments, the LP-WUS related parameter includes LP-WUS grouping information, and the LP-WUS grouping information includes an LP-WUS group to which the terminal device belongs.

In some embodiments, the operation of receiving the second configuration information transmitted by the first base station may include: receiving second signaling transmitted by the first base station; the second signaling is specific signaling of the terminal device, and the second signaling carries the second configuration information.

In some embodiments, the second signaling is an RRC connection release message.

In some embodiments, the RRC connection release message is used for indicating entry into an RRC_INACTIVE state.

In some embodiments, the first configuration information indicates enablement of the first LP-WUS function, and/or the second configuration information indicates enablement of the second LP-WUS function; the operation of determining enablement or disablement of the first LP-WUS function and/or the second LP-WUS function based on the first configuration information and/or the second configuration information may include: determining enablement or disablement of the first LP-WUS function and/or the second LP-WUS function based on the first configuration information and/or the second configuration information, and/or based on whether signal reception quality of a serving cell is greater than or equal to a threshold and/or whether the serving cell supports the LP-WUS.

In some embodiments, the first configuration information indicates enablement of the first LP-WUS function; the first indication information indicates enablement of the second LP-WUS function; the operation of determining enablement or disablement of the first LP-WUS function based on the first configuration information includes: determining enablement or disablement of the first LP-WUS function based on the first configuration information, and/or based on whether signal reception quality of a serving cell is greater than or equal to a threshold and/or whether the serving cell supports the LP-WUS; the operation of determining enablement or disablement of the second LP-WUS function based on the first indication information includes: determining enablement or disablement of the second LP-WUS function based on the first indication information, and/or based on whether signal reception quality of a serving cell is greater than or equal to a threshold and/or whether the serving cell supports the LP-WUS.

In some embodiments, the information processing apparatus 90 further includes a transmitting module, configured to report LP-WUS related capability information to the core network device; the LP-WUS related capability information is used for determining the first configuration information.

FIG. 10 is a second structural schematic diagram of an information processing apparatus according to an embodiment of the present disclosure. The information processing apparatus is implemented by a core network device. As shown in FIG. 10, an information processing apparatus 100 includes:
a transmitting module 1001, configured to transmit first configuration information to a terminal device, the first configuration information being used for configuring enablement or disablement of a first LP-WUS function and/or a second LP-WUS function, the first LP-WUS function being used for monitoring paging initiated by the core network device (CN paging), and the second LP-WUS function is used for monitoring paging initiated by the first base station (RAN paging).

In some embodiments, the transmitting module 1001 is further configured to transmit a first cycle parameter to the terminal device; the first cycle parameter is used for monitoring paging initiated by the core network device.

In some embodiments, the monitoring of paging initiated by the core network device includes paging monitoring on a PO corresponding to the paging initiated by the core network device, and the first cycle parameter is used for determining the PO corresponding to the paging initiated by the core network device.

In some embodiments, the transmitting module 1001 is further configured to transmit the first configuration information to one or more base stations; the one or more base stations belong to a range for paging the terminal device.

In some embodiments, the first configuration information transmitted to the one or more base stations is carried in at least one of the following messages:
a paging message; an initial context setup request; a UE context release command; or a UE context modification request.

In some embodiments, the first configuration information includes at least second indication information, and the second indication information is used for indicating enablement or disablement of the first LP-WUS function.

Further, in some embodiments, the first configuration information further includes an LP-WUS related parameter.

In other embodiments, the first configuration information includes an LP-WUS related parameter, and does not include the second indication information; the second indication information is used for indicating enablement or disablement of the first LP-WUS function.

Accordingly, optionally, in some embodiments, the first configuration information is used for indicating enablement of the first LP-WUS function.

In still other embodiments, the first configuration information does not include an LP-WUS related parameter or the second indication information; the second indication information is used for indicating enablement or disablement of the first LP-WUS function.

Accordingly, optionally, in some embodiments, the first configuration information is used for indicating disablement of the first LP-WUS function.

Exemplarily, in some embodiments, the LP-WUS related parameter includes LP-WUS grouping information, and the LP-WUS grouping information includes an LP-WUS group to which the terminal device belongs.

In some embodiments, the information processing apparatus 100 further includes a receiving module, configured to receive LP-WUS related capability information reported by the terminal device; the LP-WUS related capability information is used for determining the first configuration information.

FIG. 11 is a third structural schematic diagram of an information processing apparatus according to an embodiment of the present disclosure. The information processing apparatus is implemented by a first base station. As shown in FIG. 11, an information processing apparatus 110 includes:
a transmitting module 1101, configured to transmit second configuration information to a terminal device;
the second configuration information is used for configuring enablement or disablement of a first LP-WUS function and/or a second LP-WUS function;
the first LP-WUS function is used for monitoring paging initiated by a core network device (CN paging), and the second LP-WUS function is used for monitoring paging RAN paging initiated by the first base station.

In some embodiments, the transmitting module 1101 is further configured to transmit third cycle parameter to the terminal device;
the third cycle parameter is used for monitoring paging initiated by the first base station.

In some embodiments, the monitoring of paging initiated by the first base station includes paging monitoring on a PO corresponding to the paging initiated by the first base station, and the third cycle parameter is used for determining the PO corresponding to the paging initiated by the first base station.

In some embodiments, the operation of transmitting second configuration information to the terminal device may include:
transmitting second signaling to the terminal device;
the second signaling is specific signaling of the terminal device, and the second signaling carries the second configuration information.

In some embodiments, the second signaling is an RRC connection release message.

In some embodiments, the RRC connection release message is used for indicating entry into an RRC_INACTIVE state.

In some embodiments, the transmitting module 1101 is further configured to transmit the second configuration information to one or more base stations;
the one or more base stations belong to a range for paging the terminal device.

In some embodiments, the second configuration information transmitted to the one or more base stations is carried in a paging message.

FIG. 12 is a fourth structural schematic diagram of an information processing apparatus according to an embodiment of the present disclosure. The information processing apparatus is implemented by a first base station. As shown in FIG. 12, an information processing apparatus 120 includes:
a transmitting module 1201, configured to transmit third configuration information to a terminal device, and transmit the third configuration information to a core network device;
the third configuration information is used for configuring enablement or disablement of a third LP-WUS function;
paging monitoring through the third LP-WUS function is LP-WUS based monitoring.

In some embodiments, the third configuration information transmitted to the core network device is carried in at least one of the following messages:
a UE context release request; a UE context release complete; an RRC inactive transition report; or a UE context suspend request.

In some embodiments, the transmitting module 1201 is further configured to transmit the third configuration information to one or more base stations;
the one or more base stations belong to a range for paging the terminal device.

In some embodiments, the third configuration information transmitted to the one or more base stations is carried in a paging message.

In some embodiments, the operation of transmitting third configuration information to the terminal device may include:
transmitting third signaling to the terminal device;
the third signaling is specific signaling of the terminal device, and the third signaling carries the third configuration information.

In some embodiments, the third signaling is an RRC connection release message.

In some embodiments, the RRC connection release message is used for indicating entry into an RRC_INACTIVE state; or the RRC connection release message is used for indicating entry into a Radio Resource Control idle RRC_IDLE state.

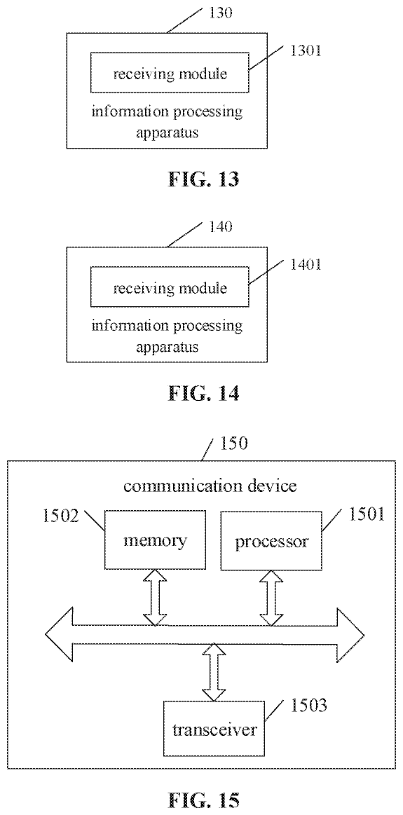

FIG. 13 is a fifth structural schematic diagram of an information processing apparatus according to an embodiment of the present disclosure. The information processing apparatus is implemented by a core network device. As shown in FIG. 13, an information processing apparatus 130 includes:
a receiving module 1301, configured to receive third configuration information transmitted by a first base station;
the third configuration information is used for configuring enablement or disablement of a third LP-WUS function of a corresponding terminal device;
paging monitoring through the third LP-WUS function is LP-WUS based monitoring.

In some embodiments, the information processing apparatus 130 further includes a transmitting module, configured to initiate paging to the terminal device based on the third configuration information after the receiving module 1301 receives the third configuration information transmitted by the first base station.

In some embodiments, the third configuration information is carried in at least one of the following messages:
a UE context release request; a UE context release complete; an RRC inactive transition report; or a UE context suspend request.

In some embodiments, the information processing apparatus 130 further includes a transmitting module, configured to transmit the third configuration information to one or more base stations;
the one or more base stations belong to a range for paging the terminal device.

In some embodiments, the third configuration information transmitted to the one or more base stations is carried in at least one of the following messages:
a paging message; an initial context setup request; a UE context release command;
or a UE context modification request.

In some embodiments, the information processing apparatus 130 further includes a transmitting module, configured to transmit fourth configuration information to a terminal device;
the fourth configuration information is used for configuring enablement or disablement of a fourth LP-WUS function;
monitoring of paging through the fourth LP-WUS function is LP-WUS based monitoring.

In some embodiments, the fourth configuration information includes at least third indication information, and the third indication information is used for indicating enablement or disablement of the third LP-WUS function.

Further, in some embodiments, the fourth configuration information further includes an LP-WUS related parameter.

In other embodiments, the fourth configuration information includes an LP-WUS related parameter, and does not include the third indication information; the third indication information is used for indicating enablement or disablement of the third LP-WUS function.

Accordingly, optionally, in some embodiments, the fourth configuration information is used for indicating enablement of the third LP-WUS function.

In still other embodiments, the fourth configuration information does not include an LP-WUS related parameter or third indication information; the third indication information is used for indicating enablement or disablement of the third LP-WUS function.

Accordingly, optionally, in some embodiments, the fourth configuration information is used for indicating disablement of the third LP-WUS function.

Exemplarily, in some embodiments, the LP-WUS related parameter includes LP-WUS grouping information, and the LP-WUS grouping information includes an LP-WUS group to which the terminal device belongs.

In some embodiments, the information processing apparatus 130 further includes a transmitting module, configured to initiate paging to the terminal device based on the fourth configuration information before the receiving module 1301 receives the third configuration information transmitted by the first base station.

In some embodiments, the receiving module 1301 is further configured to receive LP-WUS related capability information reported by the terminal device;
the LP-WUS related capability information is used for determining the fourth configuration information.

FIG. 14 is a sixth structural schematic diagram of an information processing apparatus according to an embodiment of the present disclosure. The information processing apparatus is implemented by a terminal device. As shown in FIG. 14, an information processing apparatus 140 includes:
a receiving module 1401, configured to receive third configuration information transmitted by a first base station;
the third configuration information is used for configuring enablement or disablement of a third LP-WUS function;
paging monitoring through the third LP-WUS function is LP-WUS based monitoring.

In some embodiments, the receiving third configuration information transmitted by the first base station includes:
receiving third signaling transmitted by the first base station;
the third signaling is specific signaling of the terminal device, and the third signaling carries the third configuration information.

In some embodiments, the third signaling is an RRC connection release message.

In some embodiments, the RRC connection release message is used for indicating entry into an RRC_INACTIVE state; or the RRC connection release message is used for indicating entry into an RRC_IDLE state.

In some embodiments, the receiving module 1401 is further configured to receive fourth configuration information transmitted by a core network device;
the fourth configuration information is used for configuring enablement or disablement of the third LP-WUS function;
paging monitoring through the third LP-WUS function is LP-WUS based monitoring.

In some embodiments, the fourth configuration information includes at least third indication information, and the third indication information is used for indicating enablement or disablement of the third LP-WUS function.

Further, in some embodiments, the fourth configuration information further includes an LP-WUS related parameter.

In other embodiments, the fourth configuration information includes an LP-WUS related parameter, and does not include third indication information; the third indication information is used for indicating enablement or disablement of the third LP-WUS function.

Accordingly, optionally, in some embodiments, the fourth configuration information is used for indicating enablement of the third LP-WUS function.

In still other embodiments, the fourth configuration information does not include an LP-WUS related parameter or third indication information; the third indication information is used for indicating enablement or disablement of the third LP-WUS function.

Accordingly, optionally, in some embodiments, the fourth configuration information is used for indicating disablement of the third LP-WUS function.

Exemplarily, in some embodiments, the LP-WUS related parameter includes LP-WUS grouping information, and the LP-WUS grouping information includes an LP-WUS group to which the terminal device belongs.

In some embodiments, the information processing apparatus 140 further includes a configuration module, configured to:
configure enablement or disablement of the third LP-WUS function based on latest received configuration information in a case where the receiving module 1401 has received the third configuration information transmitted by the first base station and the fourth configuration information transmitted by the core network device;
the latest received configuration information is the third configuration information or the fourth configuration information.

In other embodiments, the configuration module is further configured to:
configure enablement or disablement of the third LP-WUS function based on the third configuration information in a case where the receiving module 1401 has received the third configuration information transmitted by the first base station and the fourth configuration information transmitted by the core network device.

In still other embodiments, the configuration module is further configured to:
configure enablement or disablement of the third LP-WUS function based on the fourth configuration information in a case where the receiving module 1401 has received the fourth configuration information transmitted by the core network device and does not receive the third configuration information transmitted by the first base station.

Further, in some embodiments, the third configuration information or the fourth configuration information indicates enablement of the third LP-WUS function;
the operation of configuring enablement or disablement of the third LP-WUS function based on the third configuration information or the fourth configuration information may include:
determining whether to enable the third LP-WUS function based on the third configuration information or the fourth configuration information, and/or based on whether signal reception quality of a serving cell is greater than or equal to a threshold and/or whether the serving cell supports the LP-WUS.

In some embodiments, the information processing apparatus 140 further includes a transmitting module, configured to report LP-WUS related capability information to the core network device;
the LP-WUS related capability information is used for determining the fourth configuration information.

In some embodiments, the terminal device is in an RRC_IDLE state or an RRC_INACTIVE state.

A person skilled in the art should understand that the foregoing related descriptions of the information processing apparatuses in the embodiments of the present disclosure may be understood with reference to the related descriptions of the information processing methods in the embodiments of the present disclosure.

FIG. 15 is a schematic structural diagram of a communication device according to an embodiment of the present disclosure. The communication device may be a terminal device, an access network device, or a core network device. A communication device 150 shown in FIG. 15 includes a processor 1501. The processor 1501 may call and run a computer program from a memory to implement the methods in the embodiments of the present disclosure.

Optionally, as shown in FIG. 15, the communication device 150 may further include a memory 1502. The processor 1501 may call and run the computer program from the memory 1502 to implement the methods in the embodiments of the present disclosure. The memory 1502 may be a separate device independent of the processor 1501, or may be integrated in the processor 1501.

Optionally, as shown in FIG. 15, the communication device 150 may further include a transceiver 1503. The processor 1501 may control the transceiver 1503 to communicate with other devices, specifically, may transmit information or data to other devices, or receive information or data transmitted by other devices. The transceiver 1503 may include a transmitter and a receiver. The transceiver 1503 may further include antennas, and the number of antennas may be one or more.

Optionally, the communication device 150 may specifically be an access network device in the embodiments of the present disclosure, and the communication device 150 may implement corresponding processes implemented by the access network device in the various methods in the embodiments of the present disclosure, which are not repeated herein for brevity.

Optionally, the communication device 150 may specifically be a core network device in the embodiments of the present disclosure, and the communication device 150 may implement corresponding processes implemented by the core network device in the various methods in the embodiments of the present disclosure, which are not repeated herein for brevity.

Optionally, the communication device 150 may specifically be a mobile terminal/terminal device in the embodiments of the present disclosure, and the communication device 150 may implement corresponding processes implemented by the mobile terminal/terminal device in the various methods in the embodiments of the present disclosure, which are not repeated herein for brevity.

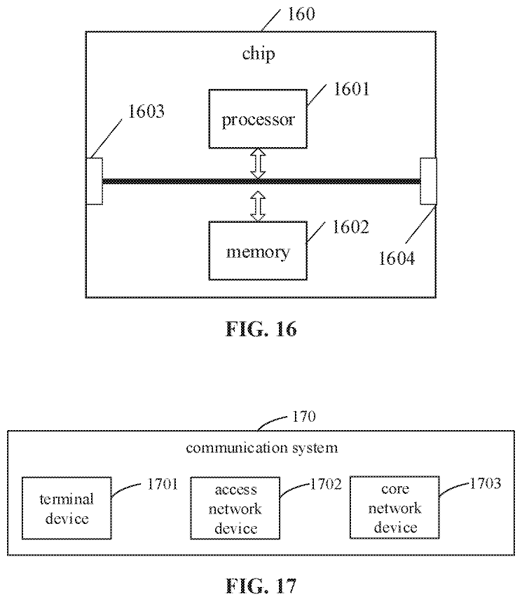

FIG. 16 is a schematic structural diagram of a chip according to an embodiment of the present disclosure. A chip 160 shown in FIG. 16 includes a processor 1601. The processor 1601 may call and run a computer program from a memory to implement the methods in the embodiments of the present disclosure.

Optionally, as shown in FIG. 16, the chip 160 may further include a memory 1602. The processor 1601 may call and run the computer program from the memory 1602 to implement the methods in the embodiments of the present disclosure. The memory 1602 may be a separate device independent of the processor 1601, or may be integrated in the processor 1601.

Optionally, the chip 160 may further include an input interface 1603. The processor 1601 may control the input interface 1603 to communicate with other devices or chips, specifically, may acquire information or data transmitted by other devices or chips.

Optionally, the chip 160 may further include an output interface 1604. The processor 1601 may control the output interface 1604 to communicate with other devices or chips, specifically, may output information or data to other devices or chips.

Optionally, the chip may be implemented by the access network device in the embodiments of the present disclosure, and the chip may implement corresponding processes implemented by the access network device in the various methods in the embodiments of the present disclosure, which are not repeated herein for brevity.

Optionally, the chip may be implemented by the core network device in the embodiments of the present disclosure, and the chip may implement corresponding processes implemented by the core network device in the various methods in the embodiments of the present disclosure, which are not repeated herein for brevity.

Optionally, the chip may be implemented by the mobile terminal/terminal device in the embodiments of the present disclosure, and the chip may implement corresponding processes implemented by the mobile terminal/terminal device in the various methods in the embodiments of the present disclosure, which are not repeated herein for brevity.

It should be understood that the chip mentioned in the embodiment of the present disclosure may also be referred to as a system-level chip, a system chip, a chip system, a system-on-chip, or the like.

FIG. 17 is a schematic block diagram of a communication system according to an embodiment of the present disclosure. As shown in FIG. 17, the communication system 170 includes a terminal device 1701, an access network device 1702, and a core network device 1703.

The terminal device 1701 may be configured to implement corresponding functions implemented by the terminal device in the foregoing methods, the access network device 1702 may be configured to implement corresponding functions implemented by the access network device in the foregoing methods, and the core network device 1703 may be configured to implement corresponding functions implemented by the core network device in the foregoing methods, which are not repeated herein for brevity.

It should be understood that the processor in the embodiment of the present disclosure may be an integrated circuit chip having a signal processing capability. In an implementation process, the operations in the foregoing method embodiments may be implemented by an integrated logic circuit of hardware in the processor or instructions in a form of software.

The processor may be a general-purpose processor, a Digital Signal Processor (DSP), an Application Specific Integrated Circuit (ASIC), a Field Programmable Gate Array (FPGA) or another programmable logic device, a discrete gate or transistor logic device, or a discrete hardware component. Various methods, operations, and logical block diagrams in the embodiments of the present disclosure may be implemented or executed. The general-purpose processor may be a microprocessor or the processor may be any conventional processor. The operations of the methods in the embodiments of the present disclosure may be directly implemented by a hardware decoding processor, or implemented by a combination of hardware and software modules in the decoding processor. The software module may be located in a mature storage medium in the art such as a random access memory, a flash memory, a read-only memory, a programmable read-only memory, an electrically erasable programmable read-only memory, or a register. The storage medium is located in the memory, and the processor reads information in the memory and completes the operations of the foregoing methods in combination with hardware thereof.

It may be understood that the memory in the embodiment of the present disclosure may be a volatile memory or a non-volatile memory, or may include both volatile and non-volatile memories.

The non-volatile memory may be a Read-Only Memory (ROM), a Programmable ROM (PROM), an Erasable PROM (EPROM), an Electrically EPROM (EEPROM), or a flash memory.

The volatile memory may be a Random Access Memory (RAM), used as an external cache. By way of example and not limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memory of the system and methods described herein is intended to include, but is not limited to, these and any other suitable types of memories.

It should be understood that the foregoing memory is exemplary and not restrictive. For example, the memory in the embodiment of the present disclosure may also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), a Direct Rambus RAM (DR RAM), or the like.

That is, the memory in the embodiment of the present disclosure is intended to include, but is not limited to, these and any other suitable types of memories.

An embodiment of the present disclosure further provides a computer-readable storage medium, configured to store a computer program.

Optionally, the computer-readable storage medium may be implemented by the access network device in the embodiments of the present disclosure, and the computer program enables a computer to execute corresponding processes implemented by the access network device in the various methods in the embodiments of the present disclosure, which are not repeated herein for brevity.

Optionally, the computer-readable storage medium may be implemented by the core network device in the embodiments of the present disclosure, and the computer program enables a computer to execute corresponding processes implemented by the core network device in the various methods in the embodiments of the present disclosure, which are not repeated herein for brevity.

Optionally, the computer-readable storage medium may be implemented by the mobile terminal/terminal device in the embodiments of the present disclosure, and the computer program enables a computer to execute corresponding processes implemented by the mobile terminal/terminal device in the various methods in the embodiments of the present disclosure, which are not repeated herein for brevity.

An embodiment of the present disclosure further provides a computer program product including computer program instructions.

Optionally, the computer program product may be implemented by the access network device in the embodiments of the present disclosure, and the computer program instructions enable a computer to execute corresponding processes implemented by the access network device in the various methods in the embodiments of the present disclosure, which are not repeated herein for brevity.

Optionally, the computer program product may be implemented by the core network device in the embodiments of the present disclosure, and the computer program instructions enable a computer to execute corresponding processes implemented by the core network device in the various methods in the embodiments of the present disclosure, which are not repeated herein for brevity.

Optionally, the computer program product may be implemented by the mobile terminal/terminal device in the embodiments of the present disclosure, and the computer program instructions enable a computer to execute corresponding processes implemented by the mobile terminal/terminal device in the various methods in the embodiments of the present disclosure, which are not repeated herein for brevity.

Optionally, the computer program may be implemented by the access network device in the embodiments of the present disclosure. When the computer program runs on a computer, the computer program enables the computer to execute corresponding processes implemented by the access network device in the various methods in the embodiments of the present disclosure, which are not repeated herein for brevity.

An embodiment of the present disclosure further provides a computer program.

Optionally, the computer program may be implemented by the core network device in the embodiments of the present disclosure. When the computer program runs on a computer, the computer program enables the computer to execute corresponding processes implemented by the core network device in the various methods in the embodiments of the present disclosure, which are not repeated herein for brevity.

Optionally, the computer program may be implemented by the mobile terminal/terminal device in the embodiments of the present disclosure. When the computer program runs on a computer, the computer program enables the computer to execute corresponding processes implemented by the mobile terminal/terminal device in the various methods in the embodiments of the present disclosure, which are not repeated herein for brevity.

A person of ordinary skill in the art may realize that the units and algorithm operations of the examples described in the embodiments herein may be implemented by electronic hardware, or a combination of computer software and electronic hardware. Whether the functions are performed by hardware or software depends on the particular application and design constraints of the technical solutions. A person skilled in the art may use different methods to implement the described functions for each particular application, but such implementation should not be considered as exceeding the scope of the present disclosure.

A person skilled in the art may clearly understand that, for the convenience and brevity of description, reference may be made to corresponding processes in the foregoing method embodiments for the specific working processes of the foregoing described system, apparatus, and unit, which are not repeated herein.

In the several embodiments provided in the present disclosure, it should be understood that the system, apparatuses, and methods may be implemented in other manners. For example, the apparatus embodiments described above are merely schematic. For example, the division of the units is only a logical function division, and there may be another division manner during actual implementation. For example, multiple units or components may be combined or may be integrated into another system, or some features may be ignored or not performed. In addition, the displayed or discussed mutual coupling or direct coupling or communication connection may be indirect coupling or communication connection through some interfaces, apparatuses or units, and may be in an electrical, mechanical or other form.

The units described as separate components may or may not be physically separated, and the components shown as units may or may not be physical units, may be located in one place, or may be distributed to multiple network units. Some or all of the units may be selected according to actual needs to achieve the objectives of the technical solutions of the embodiments.

In addition, each functional unit in each embodiment of the present disclosure may be integrated into one processing unit, or each unit may exist alone physically, or two or more units may be integrated into one unit.

When the functions are implemented in a form of a software functional unit and sold or used as an independent product, the functions may be stored in a computer-readable storage medium. Based on such an understanding, the technical solutions of the present disclosure essentially or partially contributing to the prior art, or a part of the technical solutions may be embodied in a form of a computer software product. The computer software product is stored in a storage medium, and includes several instructions for enabling a computer device (which may be a personal computer, a server, a core network device, an access network device, or the like) to execute all or part of the operations of the methods described in the embodiments of the present disclosure. The foregoing storage medium includes: any medium that can store program code, such as a USB flash drive, a removable hard disk, a Read-Only Memory (ROM), a Random Access Memory (RAM), a magnetic disk, or an optical disc.

The foregoing descriptions are merely specific implementations of the present disclosure, but the protection scope of the present disclosure is not limited thereto. Any variation or replacement readily figured out by a person skilled in the art within the technical scope in the present disclosure shall fall within the protection scope of the present disclosure. Therefore, the protection scope of the present disclosure shall be subject to the protection scope of the claims.

1. A method of information processing, comprising:
receiving, by a terminal device, at least one of first configuration information transmitted by a core network device or second configuration information transmitted by a first base station; and
determining, by the terminal device, enablement or disablement of at least one of a first low-power wake-up signal (LP-WUS) function or a second LP-WUS function based on at least one of the first configuration information or the second configuration information,
wherein the first LP-WUS function is used for monitoring of paging initiated by the core network device (CN paging); and the second LP-WUS function is used for paging initiated by the first base station (RAN paging).

2. The method according to claim 1, wherein the receiving, by a terminal device, at least one of first configuration information transmitted by a core network device or second configuration information transmitted by a first base station, and determining, by the terminal device, enablement or disablement of at least one of a first LP-WUS function or a second LP-WUS function based on at least one of the first configuration information or the second configuration information comprises:
when the terminal device is in an RRC_INACTIVE state, receiving, by the terminal device, the first configuration information, and determining, by the terminal device, the enablement or disablement of the first LP-WUS function and the second LP-WUS function based on the first configuration information.

3. The method according to claim 1, wherein the first configuration information comprises at least second indication information, the second indication information being used for indicating the enablement or disablement of the first LP-WUS function.

4. The method according to claim 3, wherein the first configuration information further comprises an LP-WUS related parameter.

5. The method according to claim 4, wherein the LP-WUS related parameter comprise LP-WUS grouping information, the LP-WUS grouping information comprising an LP-WUS group to which the terminal device belongs.

6. The method according to claim 1, wherein the first configuration information indicates the enablement of the first LP-WUS function, or the second configuration information indicates the enablement of the second LP-WUS function;
the determining, by the terminal device, enablement or disablement of at least one of a first LP-WUS function or a second LP-WUS function based on at least one of the first configuration information or the second configuration information comprises:
determining, by the terminal device, the enablement or disablement of at least one of the first LP-WUS function or the second LP-WUS function based on at least one of the first configuration information or the second configuration information, or based on at least one of whether a signal reception quality of a serving cell is greater than or equal to a threshold value or whether the serving cell supports LP-WUS, or based on at least one of the first configuration information or the second configuration information, whether a signal reception quality of a serving cell is greater than or equal to a threshold value, or whether the serving cell supports LP-WUS.

7. The method according to claim 1, further comprising:
receiving, by the terminal device, at least one of a first cycle parameter transmitted by the core network device or a second cycle parameter broadcast through system information of a base station, at least one of the first cycle parameter or the second cycle parameter being used for monitoring of paging initiated by the core network device.

8. The method according to claim 7, wherein the monitoring of paging initiated by the core network device comprises paging monitoring on a Paging Occasion (PO) corresponding to the paging initiated by the core network device, wherein at least one of the first cycle parameter or the second cycle parameter are used for determining the PO corresponding to the paging initiated by the core network device.

9. The method according to claim 1, further comprising:
receiving, by the terminal device, a third cycle parameter transmitted by the first base station, the third cycle parameter being used for monitoring of paging initiated by the first base station.

10. The method according to claim 9, wherein the monitoring of paging initiated by the first base station comprises paging monitoring on a PO corresponding to the paging initiated by the first base station, wherein the third cycle parameter is used for determining the PO corresponding to the paging initiated by the first base station.

11. The method according to claim 1, further comprising:
reporting, by the terminal device, LP-WUS related capability information to the core network device, the LP-WUS related capability information being used for determining the first configuration information.

12. A method of information processing, comprising:
transmitting, by a core network device, first configuration information to a terminal device,
wherein the first configuration information is used for configuring enablement or disablement of at least one of a first low-power wake-up signal (LP-WUS) function or a second LP-WUS function, the first LP-WUS function is used for monitoring of paging initiated by the core network device (CN paging), and the second LP-WUS function is used for paging initiated by the first base station (RAN paging).

13. The method according to claim 12, further comprising:
transmitting, by the core network device, the first configuration information to one or more base stations, wherein the one or more base stations belong to a range for paging the terminal device.

14. The method according to claim 13, wherein the first configuration information transmitted to the one or more base stations is carried in at least one of the following messages:
a paging message;
an initial context setup request;
a UE context release command; or
a UE context modification request.

15. The method according to claim 12, wherein the first configuration information comprises at least second indication information, the second indication information being used for indicating the enablement or disablement of the first LP-WUS function.

16. The method according to claim 15, wherein the first configuration information further comprises an LP-WUS related parameter.

17. The method according to claim 16, wherein the LP-WUS related parameter comprise LP-WUS grouping information, the LP-WUS grouping information comprising an LP-WUS group to which the terminal device belongs.

18. The method according to claim 12, further comprising:
transmitting, by the core network device, a first cycle parameter to the terminal device, the first cycle parameter being used for monitoring of paging initiated by the core network device.

19. The method according to claim 18, wherein the monitoring of paging initiated by the core network device comprises paging monitoring on a PO corresponding to the paging initiated by the core network device, and the first cycle parameter is used for determining the PO corresponding to the paging initiated by the core network device.

20. A terminal device, comprising:
a processor and a memory, the memory being configured to store a computer program, the processor being configured to call and run the computer program stored in the memory to cause the terminal device to:
receive at least one of first configuration information transmitted by a core network device or second configuration information transmitted by a first base station; and
determine enablement or disablement of at least one of a first low-power wake-up signal (LP-WUS) function or a second LP-WUS function based on at least one of the first configuration information or the second configuration information,
wherein the first LP-WUS function is used for monitoring of paging initiated by the core network device (CN paging); and the second LP-WUS function is used for paging initiated by the first base station (RAN paging).
